(19) United States
(12) Patent Application Publication
(10) Pub. No.: US 2013/0071682 A1
(43) Pub. Date: Mar. 21, 2013

(54) MULTI-PHASE PARTICULATES, METHOD OF MAKING, AND COMPOSITION CONTAINING SAME

(71) Applicants: Mykola Vasyl'ovych Borysenko, Kyiv (UA); Geoffrey R. Webster, JR., Gibsonia, PA (US); Shiryn Tyebjee, Allison Park, PA (US); Tetiana V. Cherniavska, Kyiv (UA); Aila Dyachenko, Bucha (UA); Iurii Gnatiuk, Kyiv (UA); Peter Kamarchik, JR., Saxonburg, PA (US); Ljiljana Maksimovic, Allison Park, PA (US); Yi J. Warburton, Sewickley, PA (US); Shantilal M. Mohnot, Murrysville, PA (US)

(72) Inventors: Mykola Vasyl'ovych Borysenko, Kyiv (UA); Geoffrey R. Webster, JR., Gibsonia, PA (US); Shiryn Tyebjee, Allison Park, PA (US); Tetiana V. Cherniavska, Kyiv (UA); Aila Dyachenko, Bucha (UA); Iurii Gnatiuk, Kyiv (UA); Peter Kamarchik, JR., Saxonburg, PA (US); Ljiljana Maksimovic, Allison Park, PA (US); Yi J. Warburton, Sewickley, PA (US); Shantilal M. Mohnot, Murrysville, PA (US)

(21) Appl. No.: 13/671,689

(22) Filed: Nov. 8, 2012

Related U.S. Application Data
(62) Division of application No. 12/639,543, filed on Dec. 16, 2009, now abandoned.
(60) Provisional application No. 61/138,717, filed on Dec. 18, 2008.
(60) Provisional application No. 61/254,853, filed on Oct. 26, 2009.

(51) Int. Cl. C09D 7/12; C09D 5/10; C09D 5/08

(52) U.S. Cl. CPC C09D 7/1216; C09D 5/08; C09D 5/10
USPC 428/561; 252/387; 524/403; 428/469; 428/470; 428/560; 428/562

(57) ABSTRACT

Provided is a method of preparing a multi-phase particulate. The method includes: (1) blending together (a) a dispersed phase component of a metal, a metal oxide, an organometallic compound, salts thereof, and/or mixtures thereof, and (b) a bulk phase component of an inorganic material different from the dispersed phase component to form an admixture; and (2) dry-milling and/or compressing the admixture for a time and at a pressure sufficient to disperse the dispersed phase component in and bind the dispersed phase component to the bulk phase component, thereby forming a multi-phase particulate. Coating compositions including the multi-phase particulate also are provided.

### CROSS-REFERENCE TO RELATED APPLICATIONS

This application is a division of U.S. patent application Ser. No. 12/639,543, filed Dec. 16, 2009, which claims the benefit of priority from U.S. Provisional Patent Application No. 61/138,717, filed Dec. 18, 2008, and U.S. Provisional Patent Application No. 61/254,853, filed Oct. 26, 2009, all of which applications are incorporated herein by reference.

### FIELD OF USE

The present invention is directed to a multi-phase particulates comprising a dispersed phase component dispersed in and bound to a bulk phase component which are particularly useful for use in compositions as corrosion inhibitors and/or catalysts.

### BACKGROUND OF THE INVENTION

Metallic corrosion is a natural process driven by thermodynamics in which elements in their metallic form obtain a lower energy state by reacting with the surrounding environment to form stable oxide ores. Most forms of corrosion are of the electrochemical type, involving the establishment of corrosion cells (i.e., galvanic cells) comprised of anode, cathodes and an electrolyte. Metal dissolution occurs at the anodes where the metal is oxidized, generating free electrons and metallic ions. The free electrons migrate to the cathodic sites and participate in reduction reactions. The circuit is completed by the flow of ionic charge through the electrolyte, resulting in the formation of hydroxide layers. Pitting corrosion occurs if the anodes and cathodes are clearly distinguishable. General corrosion occurs if numerous anodes and cathodes are very closely spaced thus indistinguishable, and change place at short intervals of time.

Corrosion inhibitors retard the rate of corrosion when added to a corrosive environment in suitable (typically low) concentrations. This is achieved without altering the concentration of corrosive species present in the environment. Most inhibitors interact with the anodic or cathodic reactions and increase the resistance to the flow of corrosion current.

Preventing corrosion of corrodible metallic substrate surfaces, e.g., steel and aluminum substrate surfaces, has been accomplished with varying degrees of success, for example, by application of various pretreatment and/or coating compositions. Essentially protective coatings are a means for separating metallic surfaces susceptible to corrosion from the environmental factors which cause corrosion. Additional corrosion control measures, such as metal pretreatment compositions, for example, metal phosphate solutions and organophosphate solutions, often are utilized in conjunction with protective coatings to enhance corrosion resistance in the event of a coating defect or a breach in the continuous film formed in the coating which might expose the metallic substrate surface to corrosion inducing conditions.

In the past, the chromates of zinc, lead and strontium were the corrosion inhibiting pigments of choice for use in such coatings. Nitrate based corrosion inhibitors also have been used effectively. However, due to health and environmental concerns, replacement of toxic chromate and nitrate corrosion inhibitive pigments, with non-toxic, environmentally safe materials is desirable.

Electrochemical impedance spectroscopy (“EIS”) is a known non-destructive tool for characterizing corrosion of coated metallic substrates. Functionally, EIS measures the electrochemical response to a small AC voltage applied over a particular frequency (Hertz) range. The magnitude of the impedance (ohm*cm²) is proportional to the insulating ability of the coating. A large impedance value therefore indicates that the coating has good barrier properties and is more corrosion-resistant because it impedes the flow of corrosive ions and moisture to the base metal.

Also, in some instances, catalysts can be difficult to disperse in various compositions or components thereof. Catalyst dispersion quality and the effective available surface area of a catalyst material can be critical to catalytic performance. It has been found that by bringing a catalyst material into intimate contact with a bulk phase material (e.g., by milling the catalyst with a carrier material), catalyst efficiency can be improved due to (i) improved dispersability of the catalyst in the composition in which it is used, and (ii) increased effective catalyst surface area.

### SUMMARY OF THE INVENTION

The present invention is directed to multi-phase particulate comprising a dispersed phase component dispersed in and bound to a bulk phase component. The dispersed phase component comprises a metal, a metal oxide, an organometallic compound, salts thereof, and/or mixtures thereof; and the bulk phase component comprises an inorganic material different from the dispersed phase component. The dispersed phase component is present in an amount ranging from 0.5 to 60 percent by weight based on total combined weight of the dispersed phase component and the bulk phase component.

Further the present invention is directed to a method of preparing a multi-phase particulate. The method comprises (1) dry-blending together (a) a dispersed phase component comprising a metal, a metal oxide, an organometallic compound, salts thereof, and/or mixtures thereof, and (b) a bulk phase component comprising an inorganic material different from the dispersed phase component to form an admixture, wherein the dispersed phase component (a) is present in an amount ranging from 0.5 to 60 percent by weight based on total combined weight of the dispersed phase component (a) and the bulk phase component (b); and (2) dry-milling and/or compressing the admixture for a time and at a pressure sufficient to disperse the dispersed phase component in and bind the dispersed phase component to the bulk phase component, thereby forming a multi-phase particulate.

The present invention also is directed to a coating composition comprising: (a) a resinous binder; and (b) a multi-phase particulate dispersed in the resinous binder. The multi-phase particulate comprises a dispersed phase component dispersed in and bound to a bulk phase component. The dispersed phase component comprising a metal, a metal oxide, an organometallic compound, salts thereof, and/or mixtures thereof, and the bulk phase component comprises an inorganic material different from the dispersed phase component. The dispersed phase component is present in an amount ranging from 0.5 to 60 percent by weight based on total combined weight of the dispersed phase component and the bulk phase component.

Also provided is a method of improving the corrosion resistance of a metallic substrate comprising providing a metallic substrate, and applying the aforementioned coating composition over the metallic substrate surface to form a coating layer on at least a portion of the metallic substrate surface.

### BRIEF DESCRIPTION OF DRAWINGS

Various non-limiting embodiments disclosed herein may be better understood when read in conjunction with the drawings, in which:

FIG. 1 shows a Bode diagram of the electrochemical impedance results for Example 23, a combination of Comparative Examples (CE) 5 & 6, CE 5, 6 and 7, tested individually, and Control 2.

FIG. 2 shows a transmission electron micrograph (TEM) of Example 27.

### DETAILED DESCRIPTION OF THE INVENTION

As used in this specification and the appended claims, the articles “a,” “an,” and “the” include plural referents unless expressly and unequivocally limited to one referent.

Additionally, for the purposes of this specification, unless otherwise indicated, all numbers expressing quantities of ingredients, reaction conditions, and other properties or parameters used in the specification are to be understood as being modified in all instances by the term “about.” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

Further, while the numerical ranges and parameters setting forth the broad scope of the invention are approximations as discussed above, the numerical values set forth in the Examples section are reported as precisely as possible. It should be understood, however, that such numerical values inherently contain certain errors resulting from the measurement equipment and/or measurement technique.

Various non-limiting embodiments of the invention will now be described.

As previously mentioned, the present invention is directed to multi-phase particulate comprising a dispersed phase component dispersed in and bound to a bulk phase component. The dispersed phase component can comprise a metal, a metal oxide, an organometallic compound, salts of any of the foregoing, and/or mixtures of any of the foregoing; and the bulk phase component comprises an inorganic material different from the dispersed phase component, wherein the dispersed phase component is present in an amount ranging from 0.5 to 60 percent by weight, such as 0.5 to 40 percent by weight, or 0.5 to 30 percent by weight, based on total combined weight of the dispersed phase component and the bulk phase component.

For purposes of the present invention the “dispersed phase” of the multi-phase particulate is a finely divided particle which is dispersed/distributed throughout a bulk phase component which also typically is a particulate material. The dispersed phase also is at least partially “bound to” the bulk phase component. That is, the dispersed phase component can be physically bound to the bulk phase component, such as by Van der Waals forces or ionic association; and/or the dispersed phase component can be chemically bound to the bulk phase component, such as through covalent bonding. The “bulk phase” can include any inorganic material different that the dispersed phase component.

Non-limiting examples of suitable materials for use as the dispersed phase component in the multi-phase particulate of the present invention can include metals, metal oxides, organometallic compounds, salts of any of the foregoing, and/or mixtures of any of the foregoing. For example, the dispersed phase component can comprise a transitional metal, a lanthanoid, an alkaline earth metal, organometallic compounds of any of the foregoing, oxides of any of the foregoing, salts of any of the foregoing, and/or mixtures of any of the foregoing, in a particular embodiment of the present invention, the dispersed phase component comprises lanthanum, cerium, yttrium, zirconium, calcium, barium, copper, boron, aluminum, manganese, magnesium, molybdenum, tungsten, zinc, tin, phosphorous, and/or organometallic compounds of any of the foregoing, and/or oxides of any of the foregoing, and/or salts of any of the foregoing, and/or mixtures of any of the foregoing.

The dispersed phase component typically comprises cerium, yttrium, calcium, boron, molybdenum, manganese, aluminum, aluminum phosphate, tungsten, mixtures thereof, and salts thereof.

As aforementioned, the bulk phase component comprises an inorganic material different from the dispersed phase component. Non-limiting examples of suitable materials for use as the bulk phase component can include silica, titanium dioxide, barium carbonate, barium sulfate, calcium carbonate, calcium silicate, magnesium carbonate, magnesium silicate, graphite, carbon black, aluminum silicate, wollstanite, halloysites, fullerenes, such as buckyballs, and carbon nanotubes, clay, hydrotalcite, diatomaceous earth, and/or talc. In a particular embodiment of the present invention, the bulk phase component comprises silica, titanium dioxide, calcium silicate, aluminum silicate, carbon black and/or barium sulfate.

In a particular embodiment of the present invention, the bulk phase component can comprise any of the art recognized siliceous filler materials. Non-limiting examples of suitable such siliceous filler materials can include inorganic oxides such as oxides of metals in Periods 2, 3, 4, 5, and 6 of Groups Ib, IIb, IIIa, IIIb, Iva, IVb (excluding carbon), Va, VIa, and VIII of the Period Table of Elements presented in Advanced Inorganic Chemistry: A Comprehensive Text, F. Albert Cotton at al., Fourth Ed., John Wiley and Sons, 1980. Specific non-limiting examples can include calcium silicate, aluminum silicates, silica such as silica gel, colloidal silica, precipitated silica, fumed silica, and mixtures of any of the foregoing.

Suitable siliceous fillers (e.g., precipitated silica) can be prepared, for example, by combining an aqueous solution of soluble metal silicate with an acid to form a slurry. Optionally, the slurry can be aged. Further acid, or a base, is then added to the slurry to adjust pH, and the slurry is filtered, optionally washed, then dried using conventional drying techniques such as spray drying or rotary drying processes. Optionally, the dried siliceous filler thus produced can be further hydrated and dried in a second drying step. Additionally, the filler can be further milled and classified if desired.

In one non-limiting embodiment of the present invention, the bulk phase component comprises precipitated silica. Suitable precipitated silicas can include, for example, those sold under the tradenames Inhibisil™, Hi-Sil™ and LoVel™ all available from PPG Industries, Inc., and those commercially available from W.R. Grace under the tradename SHIELDEX® or AEROSIL®.

In another embodiment of the present invention, the bulk phase component comprises precipitated silica and/or fumed silica, wherein the precipitated silica and/or fumed silica comprise one or more metal ions chosen from lanthanum, cerium, yttrium, zirconium, calcium, barium, copper, boron, manganese, magnesium, molybdenum, tungsten, zinc, and/or tin. See, for example, U.S. Pat. No. 4,837,253, wherein calcium ion-containing precipitated silica is described.

The bulk phase component can comprise amorphous precipitated silica derived from ash produced by thermal pyrolysis of biomass such as, for example, rice hulls, rice straw, wheat straw, sugarcane bagasse, horsetail weeds, palmyra palm and certain bamboo stems. The biogenic silica in such materials lacks distinct crystalline structure, which means it is amorphous with some degree of porosity. Any of the known processes of thermal pyrolysis can be used to produce the biogenic ash (e.g., rice hull ash), including without limitation, incineration, combustion, and gasification processes. A biogenic sodium silicate solution can be produced by caustic digestion of biogenic ash (such as rice hull ash). The sodium silicate solution/slurry typically then is heated and acidified, and the acidified slurry can be processed using separation techniques, such as vacuum filtering or filter press, for recovery of the wet solids or filter cake. The wet solids or filter cake can be washed, then dried by any of a variety of drying techniques as are discussed herein below. The dry amorphous precipitated silica then can be milled and classified to reduce particle size as desired. It has been found that the purity and other physical properties such as surface area of the amorphous precipitated silica thus prepared can be modified or enhanced by pre-treatment of the biomass prior to pyrolysis, for example by treating with hot organic acid and/or with boiling water prior to pyrolysis. For a detailed description of the aforementioned processes for obtaining amorphous precipitated silica from biogenic ash, see U.S. Pat. No. 6,638,354, and Souza, M. F. De; Magalhaes, W. L. E; and Persegil, M. C. Silica Derived from Burned Rice Hulls. Mat. Res. [online], 2002, vol. 5, n. 4, pp. 467-474 (available from: <http://www.scielo.br/scielo.php?script=sci_arttext&pid=S1516-14392002000400012&Ing=en&nrm=iso>.

The inorganic materials suitable for use as the bulk phase component in the preparation of the multi-phase particulate of the present invention may or may not be treated or modified with an organic material. Non-limiting examples of such organo-treated/modified inorganic materials, (e.g., precipitated silicas) can include those treated with mercaptoorganometallic compounds and, optionally, non-sulfur organometallic compounds the preparation of which are described in detail in U.S. Pat. No. 6,649,684 at column 7, line 6 to column 13, line 65, the cited portions of which are incorporated by reference herein. Additional non-limiting examples of suitable organo-treated/modified inorganic materials (e.g., precipitated silicas) can include those treated with bis(alkoxysilylalkyl)polysulfides and, optionally, non-sulfur organometallic compounds the preparation of which is described in detail in U.S. Pat. No. 6,642,560 at column 6, line 58 to column 13, line 34, the cited portions of which are incorporated by reference herein.

The bulk phase component can comprise organo-treated/modified inorganic material (such as precipitated silica) wherein during preparation of the inorganic material, organic non-coupling materials such as cationic, anionic and/or amphoteric surfactants; and/or coupling materials such as organosilanes (including sulfur-containing and non-sulfur-containing organosilanes) and bis(alkoxysilylalkyl)polysulfides are included in the slurry of soluble metal silicate and acid, prior to the first drying step. Such organo-treated/modified inorganic materials and the preparation thereof are described in detail in International Patent Publication No. WO 2006/110424 at paragraphs [0014] to [00101], the cited portions of which are incorporated by reference herein. The bulk phase component also can comprise one or more organofunctional inorganic materials such as organofunctional metallic materials including, but not limited to organofunctional silanes, organofunctional titanates, organofunctional zirconates and mixtures thereof wherein the organofunctional group comprises one or more reactive functional end groups. Such reactive functional end groups can include, but are not limited to, aldehyde, ally, amide, amino, carbamate, carboxylic, cyano, epoxy, glycidoxy, halogen, hydroxyl, isocyanato, mercapto, (meth)acryloxy, phosphino, polysulfide, siloxane, sulfide, thiocyanato, urethane, ureido, and/or vinyl groups. Non-limiting examples of such organofunctional metallic materials can include the materials described as aminoorganosilanes, silane coupling agents, organic titanate coupling agents and organic zirconate coupling agents described in U.S. Pat. No. 7,261,843 at column 49, line 46 to column 51, line 65; the organo silane monomers disclosed in U.S. Pat. No. 7,410,691 at column 32, line 47 to column 34, line 23; the univalent and polyvalent organofunctional groups described in U.S. Patent Publication 2008/0090971 at paragraphs [0050] to [0056]; and the monomeric and oligomeric silanes described in U.S. Patent Publication 2008/0026151 at paragraphs to [0019], the cited portions of which references being incorporated herein by reference.

The multi-phase particulate can comprise a dispersed phase component of cerium and/or yttrium, and a bulk phase component can comprise precipitated silica and/or fumed silica which may or may not be organo-treated/modified as described above.

Also, it is contemplated that either or both of the dispersed phase and the bulk phase of the multi-phase particulate of the present invention can comprise any of a variety of corrosion inhibitor materials, for example any of barium, calcium, zinc, magnesium, amine, and/or sodium-containing materials commercially available from King Industries, Inc., W.R. Grace Co., MolyWhite Pigments Group, Inc., and others. As mentioned previously, the dispersed phase component can be present in the multi-phase particulate of the present invention in an amount ranging from 0.5 to 60 percent by weight, such as 0.5 to 40 percent by weight, or 1.0 to 30 percent by weight, or 3.0 to 25 percent by weight, or 5.0 to 20 percent by weight based on total combined weight of the dispersed phase component and the bulk phase component. It should be noted that the amount of the dispersed phase component present in the multi-phase particulate can range between any of the aforementioned percentage values, inclusive of the stated values.

The present invention also is directed to a method of preparing a multi-phase particulate. The method comprises (1) blending together (a) a dispersed phase component comprising a Metal, a metal oxide, an organometallic compound, salts thereof, and/or mixtures thereof such as any of those described previously, and (b) a bulk phase component comprising an inorganic material different from the dispersed phase component as discussed previously to form an admixture, wherein the dispersed phase component (a) is present in an amount ranging from 0.5 to 60 percent by Weight, such as 0.5 to 40 percent by weight, or 1.0 to 30 percent by weight, or 3.0 to 25 percent by weight, or 5.0 to 20 percent by weight based on total combined weight of the dispersed phase component (a) and the bulk phase component (b); and (2) dry-milling and/or compressing the admixture for a time and at a pressure sufficient to disperse the dispersed phase component in and bind the dispersed phase component to the bulk phase component, thereby forming a multi-phase particulate. The method can further comprise (3) further milling and classifying the multi-phase particulate formed in (2) to reduce particle size of the multi-phase particulate. The blending of step (1) can be accomplished using a variety of techniques. The dispersed phase component (a) and the bulk phase component (b) can be blended using dry-blending methods as described below.

By “dry-blending” is meant combining the dispersed phase component (a) with the bulk phase component (b) under low shear to mix the two components in the absence of any added solvent or diluent (e.g., in the absence of any added water or added organic materials) to form a dry admixture. The admixture of (a) and (b) then is dry-milled and/or compressed. The dry-milling and/or compression of the admixture also is done in the absence of any purposefully added solvent or diluent (e.g., without the addition of water or organic materials). The dry-milling and/or compression of the dry admixture serves to bring the dispersed phase (a) and the bulk phase component (b) into intimate contact for a time and a pressure sufficient to disperse the dispersed phase component (a) in and bind it to the bulk phase component (b).

Alternatively, if desired the dry-blending and dry-milling steps can be accomplished simultaneously in a single step. For example, the dispersed phase component (a) and the bulk phase component (b) each separately can be added as a dry ingredient, i.e., each as a separate feed, to any of a variety of the mills or compression devices as described herein below, and the dry-blending step and the dry-milling and/or compression step are thus simultaneously accomplished as the components are milled and/or compressed.

Dry-milling can be accomplished through any of a variety of horizontal and vertical milling techniques, and any of a variety of media milling: techniques as are well known in the art. Dry-milling can be accomplished by milling techniques such as but not limited to ball milling, jet milling, attritor miffing, hammer sonicating, V-milling, roller milling, impact milling, and combinations of the any of the foregoing. The dry admixture may be compressed in addition to or in lieu of the dry-milling. Compression of the dry admixture can be accomplished through any of a variety of compression techniques, including by not limited to use of a granulator as are well known in the art.

The above-described method can further comprise (3) further milling and classifying the multi-phase particulate formed in (2), for example, where further particle size reduction is desired. Non-limiting examples of suitable particle size reduction techniques can include grinding and pulverizing, such as through the use of a fluid energy mill or micronizer as are well known in the art.

It should be noted herein that where oxides of any of the aforementioned materials are used as the dispersed phase component and/or the bulk phase components during the dry-milling process described above, water may be adsorbed onto the surface(s) of the components used to prepare the multi-phase particulate, and/or water may be generated in situ. That is, even though there is no solvent added during the dry-blending or dry-milling steps, water may nonetheless be adsorbed onto the surface of the components, or water may be formed by the reaction of the hydroxide with hydroxyls present on the components. Thus, if necessary an optional drying step is contemplated to remove any water that may be formed during the preparation of the multi-phase particulate.

The above-described method can further comprise (3) further milling and classifying the multi-phase particulate formed in (2), for example, where further particle size reduction is desired. Non-limiting, examples of suitable particle size reduction techniques can include grinding and pulverizing, such as through the use of a fluid energy mill or micronizer as are well known in the art.

Alternatively, the present invention is directed to a method of preparing a multi-phase particulate comprising:
(1) blending together (a) a dispersed phase component comprising a metal, a metal oxide, an organometallic compound, salts thereof, and/or mixtures thereof, and (b) an aqueous slurry of a bulk phase component comprising an inorganic material different from the dispersed phase component to form an aqueous slurry admixture, wherein the dispersed phase component (a) is present in an amount ranging from 0.5 to 60 percent by weight based on total combined weight of the dispersed phase component (a) and the bulk phase component (b);
(2) drying, by any of the aforementioned drying techniques, the aqueous slurry admixture to form a dry admixture; and
(3) dry-milling and/or compressing the dry admixture for a time and at a pressure sufficient to disperse the dispersed phase component in and bind the dispersed phase component to the bulk phase component, thereby forming a multi-phase particulate. The above-described method can further comprise (4) further milling and classifying the multi-phase particulate formed in (3), for example, where further particle size reduction is desired. Non-limiting examples of suitable particle size reduction techniques can include grinding and pulverizing, such as through the use of a fluid energy mill or micronizer as are well known in the art.

For purposes of this particular embodiment, it should be understood that the dispersed phase component (a) may be added in a dry form under mild agitation to an aqueous slurry of the bulk phase component (b), thereby forming an aqueous slurry admixture which subsequently is dried, and dry-milled and/or compressed. Alternatively, the dispersed phase component (a) may be added in the form of an aqueous slurry to an aqueous slurry of the bulk phase component (b), thereby forming an aqueous slurry admixture which subsequently is dried, and dry-milled and/or compressed.

Further, the present invention is directed to a method of preparing a multi-phase particulate comprising:
(1) milling together, typically in the presence of milling media, (a) a dispersed phase component comprising a metal, a metal oxide, an organometallic compound, salts thereof, and/or mixtures thereof, and (b) a bulk phase component comprising an inorganic material different from the dispersed phase component in the presence of a liquid solvent (comprising water and/or organic solvent) for a time and at a pressure sufficient to disperse the dispersed phase component in and bind the dispersed phase component to the bulk phase component, thereby forming a wet-milled multi-phase particulate, wherein the dispersed phase component (a) is present in an amount ranging from 0.5 to 60 percent by weight based on total combined weight of the dispersed phase component (a) and the bulk phase component (b);
(2) optionally drying, by any of the aforementioned drying techniques, the wet-milled multi-phase particulate; and
(3) optionally further milling and/or compressing the dried milled product.

Examples of suitable milling media can include any of those well known in the art, such as stone, glass, metal, metal carbide and ceramic materials. Suitable ceramic miffing media can include, but are not limited to zirconium silicate and zirconium silicate doped with cerium and/or yttrium. The milling can be accomplished using any of the art recognized wet mills, for example horizontal and vertical wet grinding mills.

For purposes of this particular embodiment, it should be understood that the dispersed phase component (a) may be added in a dry form under mild agitation to a slurry of the bulk phase component (b) and the liquid solvent prior to milling. Alternatively, the dispersed phase component (a) may be added in the form of a slurry to a slurry of the bulk phase component (b), thereby forming a slurry admixture which subsequently is milled, optionally dried, and optionally further milled and/or compressed.

The above-described method can further comprise further milling and classifying the multi-phase particulate, for example, where further particle size reduction is desired. Non-limiting examples of suitable particle size reduction techniques can include grinding and pulverizing, such as through the use of a fluid energy mill or micronizer as are well known in the art.

The particle size of the multi-phase particulate can vary widely depending upon the starting materials (i.e., dispersed phase component (a) and bulk phase component (b)) and the desired end use for the multi-phase particulate.

Further, the multi-phase particulate of the present invention can have a BET surface area of from 25 to 1000 square meters per gram, or from 50 to 500 square meters per gram, or from 75 to 400 square meters per gram, or from 100 to 300 square meters per gram. The BET surface area can range between any of the recited values, inclusive of those values. The surface area can be measured using conventional techniques known in the art. As used herein and the claims, the surface area is determined by the Brunauer, Emmett, and Teller (BET) method in accordance with ASTM D1993-91. The BET surface area can be determined by fitting pressure point from a nitrogen sorption isotherm measurement made with a Micrometrics TriStar 3000™ instrument. A FlowPrep-060™ station provides heat and a continuous gas flow to prepare samples for analysis. Prior to nitrogen sorption, the multi-phase particulate samples are dried by heating to a temperature of 160° C. in flowing nitrogen (P5 grade) for at least one (1) hour.

Further, the present invention is directed to a coating composition comprising:

(a) resinous binder; and

(b) a multi-phase particulate such as any of those disclosed previously herein dispersed in the resinous binder. Generally, the resinous binder is a film forming resinous composition. The coating composition(s) of the present invention may be water-based or solvent-based liquid compositions, or, alternatively, in solid particulate form, i.e., a powder coating.

The coating composition(s) of the present invention can comprise any of a variety of thermoplastic and/or thermosetting resinous binder compositions known in the art. Suitable thermosetting coating compositions typically comprise a resinous binder comprising a crosslinking agent that may be selected from, for example, aminoplasts, polyisocyanates including blocked isocyanates, polyepoxides, beta-hydroxyalkylamides, polyacids, anhydrides, organometallic acid-functional materials, polyamines, polyamides, and mixtures of any of the foregoing.

Thermosetting or curable coating compositions typically also comprise film forming resinous binder systems including polymers having functional groups that are reactive with the crosslinking agent. The resinous binder may be selected from any of a variety of polymers well-known in the art. The resinous binder can be selected, for example, from acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art. Such polymers may be solvent borne or water dispersible, emulsifiable, or of limited water solubility. The functional groups present on the resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of resinous binders may also be used in the preparation of the coating compositions.

If desired, the coating composition can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic co-solvents, catalysts, including phosphonic acids and other customary auxiliaries.

It is contemplated that certain of the multi-phase particulates of the present invention can be used as a catalyst, where appropriate, in any of the coating compositions described above. For example, either or both of the dispersed phase (as described above) and the bulk phase (as described above) of the multi-phase particulate can comprise a catalyst material. That is, the dispersed phase itself can be a catalyst material, or the dispersed phase can further comprise a catalyst material; and/or the bulk phase itself can be a catalyst material, or the bulk phase can further comprise a catalyst material. Suitable non-limiting examples of catalyst materials useful for this purpose can include bismuth oxides, bismuth carboxylates and other bismuth salts such as any of the catalyst materials sold under the tradename K-KAT® (e.g., K-KAT 348, and K-KAT XC-C227) available from King Industries, Inc.; and any of a variety of tin catalyst materials such as those sold under the tradename FASCAT® (e.g., FASCAT 2000 series of stannous tin catalysts, FASCAT 4000 series of organotin catalysts, and FASCAT 9000 series of organotin catalysts) distributed by Brennatag.

Application of the above-described coating compositions which contain the multi-phase particulate(s) of the present invention to metallic substrate(s) has proven to enhance corrosion resistance of the metallic substrate(s). Thus the present invention also is directed to a multilayer composite comprising: (a) a metallic substrate; and (b) at least one coating layer over at least a portion of the metallic substrate, the coating layer formed from any of the previously described coating compositions comprising the multi-phase particulate in accordance with the present invention.

The at least one coating layer can be in direct contact with the metallic substrate or indirect contact with the metallic substrate through one or more other layers, structures or materials, at least one of which is in direct contact with the substrate. Thus, according to various non-limiting embodiments disclosed herein, the at least one coating can be in direct contact with at least a portion of the substrate or it can be in indirect contact with at least a portion of the substrate through one or more other layers, structures or materials.

Suitable metallic substrates can include, but are not limited to, cold rolled steel; stainless steel; steel surface-treated with any of zinc metal, zinc compounds and zinc alloys; copper; magnesium, and alloys thereof; aluminum alloys; zinc aluminum alloys; aluminum plated steel; aluminum alloy plated steel substrates, and aluminum, aluminum alloys, aluminum clad aluminum alloys. The metallic substrate also can comprise cold rolled steel pretreated with a solution of a metal phosphate solution, an aqueous solution containing a Group IIA, Group IIIA, Group IB, Group IIB, Group IIIB, Group IVB, Group VIB, Group VIIB, and/or Group VIII metal, an organophosphate solution, and/or an organophosphonate solution. It should be understood that any of the previously mentioned pretreatment solutions can also include an organic resinous component. Examples of suitable pretreatment solutions can include ZIRCOBOND available from PPG Industries, Inc.

It has been found using EIS techniques (as described in detail in the Examples provided herein below) that, at a frequency of 1 Hertz or lower, the multi-layer composite of the present invention maintains an impedance of at least 1×10⁸ ohm*cm² for at least 1000 hours of exposure to salt spray testing in accordance with ASTM B117, Such an impedance value indicates that the coating formed from the coating composition comprised of the multi-phase particulate of the present invention has good barrier properties and exhibits excellent corrosion-resistance because it impedes the flow of corrosive ions and moisture to the metallic substrate to which it is applied.

Various non-limiting embodiments disclosed herein are illustrated in the following non-limited examples.

### EXAMPLES

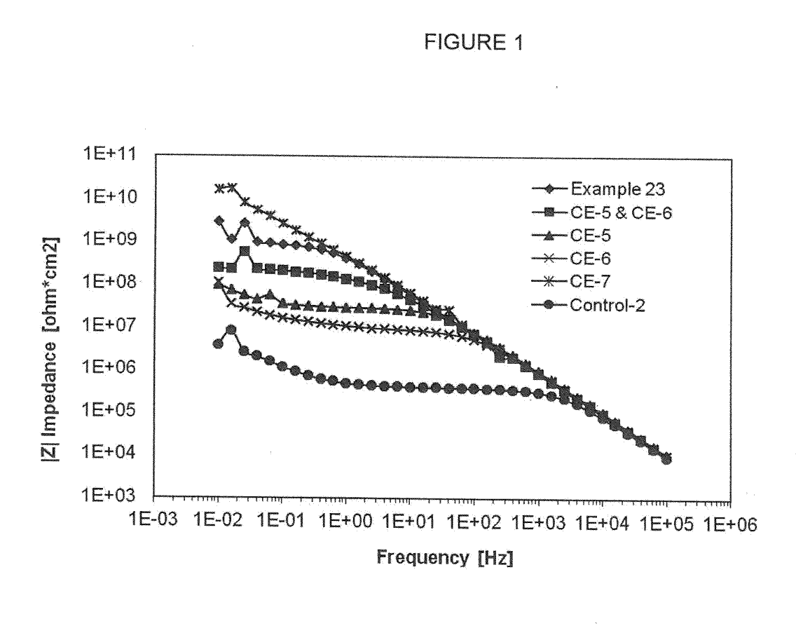

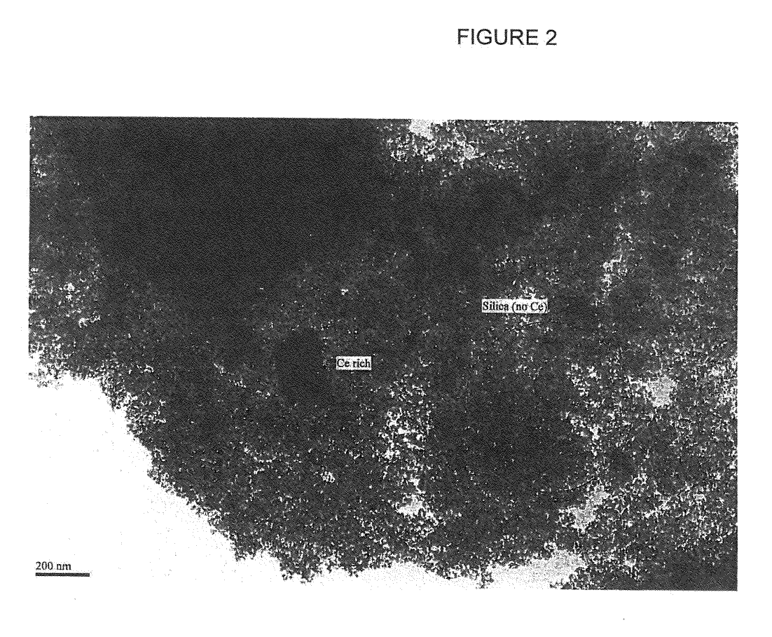

Part A describes the preparation of Examples 1-26 and Comparative Examples (CE) 1-6. Part B describes the preparation of coating primers and testing of Examples 1-8, 12-19, 23-25, CE1-8, Controls-1 & 2 and Electrochemical Impedance Spectroscopy results shown as FIG. 1. Part C describes the preparation of electrodepositable paints and testing of Examples 9-11, 20-22 and 26 and CE-6A. Part 0 describes the preparation of Example 27 and a transmission electron micrograph (TEM) of the example material as FIG. 2.

### Part A—Example Description

### Examples 1-11 and Comparative Example 1 and 2

In Examples 1 to 10, samples of commercially available precipitated silica and cerium oxide (REacton® cerium (IV) oxide, 99.9% (REO) from Alfa Aesar) were blended together into a dry mixture using a V-blender (Model LB-6677 from the Patterson-Kelley Co. Inc) set at 18 rpm (revolutions per minute) for 20 minutes. In Example 11, yttrium oxide (REacton® yttrium (III) oxide, 99.9% (REO) from Alfa Aesar) was used in addition to the cerium oxide. Examples 1, 3, 4, 9, 10 and 11 were subsequently formed into pellets using an Alexanderwerk Roller Compactor fitted with WP 120 mm×40 mm rolls (both of which were knurled rolls) at the pressures specified in Table 1. The resulting mixtures and pellets were individually milled to reduce particle size to the distribution listed in Table 1.

Examples 1 to 11 and Comparative Examples 1 and 2 were milled using a fluid energy mill fed by Vibration Equipment feeder (Serial #EE07 4656 from Eriez Magnetics) which was set on a feed rate of 3.0 to 3.5 on the dial control. The fluid energy mill (Serial #845, from the Jet Pulverizer Co) was used at a feed of 80 psi (552 kPa) and grind of 60 psi (414 kPa). The resulting particles were classified to the specified particle size range with an Acucut™ Classifier, Model A-12 using an air setting equal to 10 inches of water (2.5 kPa) at 2500 rpm.

The particle size distribution based on percent volume of the sample was determined using a Coulter LS230 Particle Size Analyzer having a laser with a wavelength of 750 nm (nanometers) according to the Product Manual dated May 1994 with revisions of 10/94 except for the following: the refractive index used for silica was 1.434 instead of 1.450; sample was added to the Particle Size Analyzer until the sample obscuration equaled 7 to 10% instead of 8 to 12% and the Polarization Intensity Differential Scattering (PIDS) equaled 57 to 87% instead of 45 to 55%. The following procedure was used for the preparation and processing of the samples: 2 grams of a particle sample that had been loosened by inverting the closed container several times was added to a 250 mL beaker and 100 mL of deionized water was added; the resulting dispersion was mixed for 10 minutes at 1000 rpm with a LIGHTNIN® LabMaster™ Mixer (Model L1U03 equipped with an A-100 propeller). If the sample could not be dispersed in deionized water a mixture of 50 mL of isopropyl alcohol and 50 mL of deionized water was used. The run length was 90 seconds to yield the particle size distribution listed in Table 1.

According to the particle size distribution listed in Table 1 for Example 1: 2% or less of the volume of sample contained particles having a particle size less than or equal to 1.02 microns; 50% or less of the volume of sample had a particle size less than or equal to 3.36 microns (the median value); and 99.9% or less had a particle size less than or equal to 11.27 microns. According to Application Information bulletin A-1994A, “Particle Size Characterization—Using Laser Diffraction Analysis in Pigment Sizing” by Beckman Coulter, “The mathematical models used to calculate distributions are based on scattering of light by a sphere. So any reported distribution is, in effect, an equivalent spherical distribution of the material being analyzed.”

TABLE 1
Description of Examples 1-11 and Comparative Examples 1 and 2

| | | | | | Roller | % Volume | | |
|---|---|---|---|---|---|---|---|---|
| | | | | | Compactor | Particle size distribution | | |
| | | Silica | CeO₂ | Y₂O₃ | pressure | (microns) | | |
| Example # | Silica type | Wt % | Wt % | Wt % | (bar) | ≦2% | ≦50% | ≦99.9% |
| 1 | Hi-Sil ® | 94 | 6 | 0 | 75 | 1.02 | 3.36 | 11.27 |
| | 2000 | | | | | | | |
| 2 | Hi-Sil ® | 94 | 6 | 0 | — | 1.51 | 3.6 | 8.93 |
| | 2000 | | | | | | | |
| 3 | Hi-Sil ® | 94 | 6 | 0 | 75 | 0.1 | 4.15 | 9.53 |
| | 2000 | | | | | | | |
| 4 | Hi-Sil ® | 88 | 12 | 0 | 75 | 2.03 | 4.16 | 9.28 |
| | 2000 | | | | | | | |
| 5 | Flo-Gard ® | 94 | 6 | 0 | — | 0.1 | 2.32 | 9.41 |
| | SP | | | | | | | |
| 6 | Silene ® | 94 | 6 | 0 | — | 0.09 | 1.23 | 9.32 |
| | 732D | | | | | | | |
| 7 | Hi-Sil ® | 94 | 6 | 0 | — | 0.15 | 2.81 | 8.77 |
| | WB-10 | | | | | | | |
| 8 | Hi-Sil ® | 88 | 12 | 0 | — | 0.09 | 0.89 | 10.69 |
| | 2000 | | | | | | | |
| 9 | Hi-Sil ® | 80 | 0 | 20 | 75 | 0.10 | 1.51 | 9.41 |
| | 2000 | | | | | | | |
| 10 | Lo-Vel ® | 80 | 20 | 0 | 75 | 0.09 | 0.92 | 9.48 |
| | 2003 | | | | | | | |
| 11 | Lo-Vel ® | 80 | 10 | 10 | 75 | 0.09 | 1.14 | 9.58 |
| | 2003 | | | | | | | |
| CE-1 | Hi-Sil ® | 100 | 0 | 0 | — | 2.55 | 5.68 | 15.3 |
| | 2000 | | | | | | | |
| CE-2 | — | 0 | 100 | 0 | — | 1.09 | 8.80 | 53.97 |

### Examples 12-19

Examples 12-19 were prepared by adding the cerium oxide used above to a precipitated silica cake prepared according to the description in U.S. Pat. No. 5,412,018 at column 2, line 40 to column 6, line 19, except that the filter cake was washed until the salt level was less than or equal to 0.5 weight percent, based on the total weight of the filter cake. The silica cake preparation procedure is incorporated herein by reference. The cerium oxide was added to the precipitated silica cake in a Dispersator mixer from Premier Mill Corp, Reading Pa. (Serial number: 25-0075). The Dispersator was equipped with a 3″ (7.6 cm) Cowles high sheer blade and the samples were mixed for 10 to 15 minutes under maximum conditions. The resulting silica cerium oxide slurry was then dried either by spray drying with a NIRO® Atomizer spray dryer or by rotary drying as indicated in Table 2. Prior to rotary drying the level of moisture was initially reduced by pulling a vacuum through the sample in a Buchner funnel equipped with filter paper to form a filter cake of 15 to 25 weight percent solids. The resulting filter cake was placed in a 12″ (30.5 cm) rotary dryer by Acerotool Inc., New Kensington Pa. DWG no. 27-42104 until the moisture was reduced to about 3 to 7%. Slurry having from 13 to 20 weight percent solids was fed to the NIRO® Atomizer Spray Dryer from GEA Process Engineering, Denmark, and dried to a moisture level comparable to rotary drying using an inlet temperature of from 110 to 120° C. and outlet temperature of 400° C. and feed pump pressure of 5 to 20 psi (34.5 to 138 kPa).

Examples 12, 14, 16 and 18 were run through the Alexanderwerk Roller Compactor using the aforedescribed procedure for granulating Examples 1-11, Examples 12-19 were milled to reduce particle size using a fluid energy mill and classified to the specified particle size range with an Acucut™ Classifier, Model A-12 following the procedure used for Examples 1-9. The particle size distribution was determined using a Coulter LS230 Particle Size Analyzer using the aforedescribed procedure for Example 1-9. Results are listed in Table 2.

TABLE 2
Description of Example 12-19

| | | | | Roll | | | |
|---|---|---|---|---|---|---|---|
| Ex- | | | | Com- | | | |
| am- | | | | pactor | Final particle size | | |
| ple | Silica | CeO₂ | Drying | pressure | distribution (microns) | | |
| # | Wt. % | Wt. % | method | (bar) | ≦2% | ≦50% | ≦99.9% |
| 12 | 94 | 6 | Spray | 75 | 0.88 | 2.64 | 18.45 |
| 13 | 94 | 6 | Spray | None | 0.14 | 4.02 | 10.76 |
| 14 | 94 | 6 | Rotary | 75 | 3.23 | 5.42 | 10.64 |
| 15 | 94 | 6 | Rotary | None | 0.09 | 4.22 | 12.93 |
| 16 | 88 | 12 | Spray | 75 | 2.01 | 4.56 | 10.96 |
| 17 | 88 | 12 | Spray | None | 0.25 | 4.73 | 10.67 |
| 18 | 88 | 12 | Rotary | 75 | 0.09 | 4.46 | 9.71 |
| 19 | 88 | 12 | Rotary | None | 2.25 | 4.61 | 10.42 |

Comparative Examples 3 and 4 were commercially available products used directly in the preparation of primers in Part B. Comparative Example 3 (CE-3) was INHIBISIL® 33 anticorrosion pigment available from PPG Industries and Comparative Example 4 (CE-4) was SHELDEX® 0303 anti-corrosion pigment available from GRACE.

In Examples 20 to 22, samples of commercially available precipitated silica and butyl stannoic acid (BSA), FASCAT® 4100 Catalyst available from Arkema Inc., were blended together. They were formed into a dry mixture using a V-blender (Model LB 6677 from the Patterson-Kelley Co. Inc) set at 18 rpm (revolutions per minute) for 20 minutes. The resulting mixtures were formed into pellets using an Alexanderwerk Roller Compactor fitted with WP 120 mm×40 mm rolls (both of which were knurled) at the pressures specified in Table 3. The resulting materials were individually milled to reduce particle size to the distribution listed in Table 3, Milling was done with the fluid energy mill used for Examples 1-11 and Comparative Examples 1 and 2 under the same conditions.

The resulting particles were classified to the specified particle size range with an Acucut™ Classifier, Model A-12 using an air setting equal to 10 inches of water (2.5 kPa) at 2500 rpm. The particle size distribution was determined using a Coulter LS230 Particle Size Analyzer previously described except that the following procedure was used for the preparation and processing of the samples: 1 gram of a particle sample that had been loosened by inverting the closed container several times was added to a 250 mL beaker and 100 mL of deionized water was added; 10 mL of Triton X surfactant was added to Example 22 to aid in the dispersion of the treated silica; the resulting dispersion was mixed for 10 minutes at 1000 rpm with a LIGHTNIN® LabMaster™ Mixer (Model L1U03 equipped with an A-100 propeller); the resulting sample was added to the Particle Size Analyzer until the sample obscuration equaled 6 to 7% or the Polarization Intensity Differential Scattering (PIDS) equaled 78 to 82%, whichever occurred first and the run length was 90 seconds (sec.) to yield the particle size distribution listed in Table 3. Note that Example 22 was sonicated for 120 sec, prior to analysis.

TABLE 3
Description of Examples 20-22

| | | | | Roller | | | |
|---|---|---|---|---|---|---|---|
| | | | | Com- | | | |
| | | | | pactor | Average particle size | | |
| Exam- | Silica | Silica | BSA | pressure | distribution (microns) | | |
| ple # | type | Wt % | Wt % | (bar) | ≦2% | ≦50% | ≦99.9% |
| 20 | Lo-Vel ® | 95 | 5 | 75 | 0.10 | 1.63 | 5.44 |
| | 2003 | | | | | | |
| 21 | Lo-Vel ® | 80 | 20 | 75 | 0.09 | 1.73 | 14.4 |
| | 2003 | | | | | | |
| 22 | Lo-Vel ® | 70 | 30 | 75 | 0.10 | 1.65 | 20.3 |
| | 2003 | | | | | | |

The amounts of cerium oxide (99.9% from Aldrich Chemicals) and Lo-Vel® 2003 silica listed in Table 4 were used in Example 23 and Comparative Examples 5 and 6. The materials were transferred to a 2 liter ball mill container and mixed with a spatula. Alumina cylinders, 220 individual cylinders measuring 1.3 cm long by 1.3 cm diameter, were placed into the ball mill container. The container was sealed and the dry-blended materials were dry-milled for 3 hours at a rotational speed of 1 revolution per second. After the milling, the sample was classified using a 0.25 mm sieve.

TABLE 4
Description of Example 23 and Comparative Examples 5 and 6

| | Weight (grams) | | |
|---|---|---|---|
| Material | Example 23 | CE-5 | CE-6 |
| CeO₂ | 6 | 100 | 0 |
| Lo-Vel ® 2003 silica | 94 | 6 | 100 |

The procedure used for milling the materials of Example 23 and Comparative Examples 5 and 6 was followed to prepare Examples 24, 25 and 26. The amounts of the materials used are listed in Table 5, The magnesium oxide was >98% ACS reagent from Aldrich Chemicals. The boric acid (H₃BO₃) was >99.5% from Aldrich Chemicals. The yttrium oxide was REacton® yttrium (III) oxide, 99.9% (REO) from Alfa Aesar. The cerium oxide was also obtained from Aldrich as previously described.

TABLE 5
Description of Examples 24, 25 and 26

| | Weight (grams) | | |
|---|---|---|---|
| Material | Example 24 | Example 25 | Example 26 |
| MgO | — | — | 30 |
| H₃BO₃ | — | — | 10 |
| Y₂O₃ | 5 | 12 | — |
| Lo-Vel ® 2003 | 95 | 88 | 60 |
| silica | | | |

### Part B—Preparation of Coating Primers and Testing of Examples 1-8, 12-19, 23-25 and CE-1-8

Step 1A—Preparation of DYNAPOL® L411 polyester resin solution

To a suitable vessel equipped with a mixer having an impellor blade the following materials were added with mixing in the order listed until homogenous: DYNAPOL® L411 polyester resin (100.00 grams); Aromatic Solvent 150 (116.67 grams), available from TEXACO; and Dibasic esters (116.67 grams), reported to be a mixture of dimethyl esters available from INVISTA.

### Step 1B—Preparation of Polyester Resin A

Polyester Resin A was prepared by adding Charge #1 (827.6 grams of 2-methyl 1,3-propanediol, 47.3 grams of trimethylol propane, 201.5 grams of adipic acid, 663.0 grams of isophthalic acid, and 591.0 grams of phthalic anhydride) to a round-bottomed, 4-necked flask equipped with a motor driven stainless steel stir blade, a packed column connected to a water cooled condenser and a heating mantle with a thermometer connected through a temperature feed-back control device. The reaction mixture was heated to 120° C. in a nitrogen atmosphere. All components were melted when the reaction mixture reached 120° C. and the reaction was then heated to 170′C at which temperature the water generated by the esterification reaction began to be collected. The reaction temperature was maintained at 170° C. until the distillation of water began to significantly slow, at which point the reaction temperature was increased by 10° C. This stepwise temperature increase was repeated until the reaction temperature reached 240° C. When the distillation of water at 240° C. stopped, the reaction mixture was cooled to 190° C., the packed column was replaced with a Dean-Stark trap and a nitrogen sparge was started, Charge #2 (100.0 grams of Solvesso 100 and 2.5 grams of titanium (IV) tetrabutoxide) was added and the reaction was heated to reflux (about 220° C.) with continuous removal of the water collected in the Dean-Stark trap. The reaction mixture was held at reflux until the measured acid value was less than 8.0 mg KOH/gram. The resulting resin was cooled, thinned with Charge #3 (1000.0 grams of Solvesso 110), discharged and analyzed. The determined acid value was 5.9 mg KOH/gram, and the determined hydroxy value of 13.8 mg KOH/gram. The determined non-volatile content of the resin was 64.1% as measured by weight loss of a sample heated to 110° C. for 1 hour. Analysis of the polymer by GPO (using linear polystyrene standards) showed the polymer to have an M_{w} value of 17,788, Mₙ value of 3,958, and an M_{w}/Mₙ value of 4.5.

### Step 1C—Preparation of Phosphatized Epoxy Resin

Phosphatized epoxy resin was prepared by dissolving 83 parts by weight of EPON® 828 epoxy resin (a polyglycidyl ether of bisphenol A, commercially available from Resolution Performance Products) in 20 parts by weight 2-butoxyethanol. The epoxy resin solution was subsequently added to a mixture of 17 parts by weight of phosphoric acid and 25 parts by weight 2-butoxyethanol under a nitrogen atmosphere. The blend was stirred for about 1.5 hours at a temperature of about 115° C. to form a phosphatized epoxy resin. The resulting resin was further diluted with 2-butoxyethanol to produce a composition which was about 55 percent by weight solids.

### Step 2A—Preparation of Primer Intermediate of Examples 1-8, 12-19 and Comparative Examples 1, 3 & 4

To a suitable vessel equipped with a mixer having a Cowles blade was added the following materials with mixing in the order listed: DYNAPOL® L411 polyester resin solution from Step 1A (137.43 grams); AEROSIL® 200 fumed silica (0.59 gram); KRONOS® TiO₂ Type 2160 (10.80 grams); HALOX® zinc phosphate anti-corrosive pigment (7.36 grams); and individually, Examples 1-8, 12-19 and Comparative Examples 1, 3 and 4 (7.36 grams). Materials were mixed with the Cowles blade at a speed fast enough to form a vortex. Mixing continued for the time necessary to achieve a 6 or higher Hegman reading, which was typically 20 minutes or longer.

### Step 2B—Preparation of Primer Intermediates of Mixtures and Reduced Levels of Comparative Examples 1 and 2

The procedure of Step 2A was followed except that in place of 7.36 grams of example material the following amounts were used: 6.48 grams of CE-1 was used in Comparative Example 1A (CE-1A); 6.48 grams of CE-1 and 0.88 gram of CE-2 were used in Comparative Example 1-2 (CE-1-2); and 0.88 gram of CE-2 was used in Comparative Example 2A (CE-2A).

### Step 2C—Preparation of Primer Intermediate for Examples 23, 24 & 25 and Comparative Examples 4, 5 & 6

To a suitable vessel equipped with a mixer having an impellor blade was added the following materials with mixing in the order listed in parts by weight (pbw) until homogenous (about 30 minutes): the products of Step 1B (2906.8 pbw) and Step 1-C (194.9 pbw); CYMEL® 1123 resin (391.5 pbw); n-butanol (71.9 pbw): and CYCAT® 4040 catalyst (11.99 pbw).

### Step 3A—Preparation of Primers for Examples 1-8, 12-19, CE 1-4 and Control-1

To a suitable vessel equipped with a mixer having an impellor blade was added the following materials with mixing in the order listed until homogenous: the individual products of Step 2A and Step 2B; CYMEL® 303 resin (16.88 grams); EPON™ 828 resin (1.88 grams); CYCAT® 4040 catalyst (0.59 gram); and ethyl-3-ethoxypropionate (12.96 grams). The resulting viscosity of the primer solutions was reduced to 60±5 seconds (#4 Zahn Cup) with a 1:1 weight based ratio of Aromatic Solvent 150/Dibasic ester. A primer without the addition of an Example or Comparative Example material (Control-1) was included for the CRS panel test.

### Step 3B—Preparation of Coating Primers for Example 23 and CE 5 & 6

Materials 1-8, listed as parts by weight (pbw) in Table 6 for each of the Coating Primers, were sequentially added to a suitable vessel equipped with a media milling blade and 1 mm Zircoa beads and milled under high shear until a reading of 6-7 on a Hegman gauge was obtained (about 30 minutes), Materials 7 and 8 were then added while the paint was milled an additional 10 minutes. The milling beads were filtered out with a standard paint filter and the resulting primer (P) was used in the next step.

TABLE 6
Preparation of Primers (P1-5) Using Example 23 and CE-5 & 6

| Component | | P1 | P2 | P3 | P4 | P5 |
|---|---|---|---|---|---|---|
| No. | Material | PBW | PBW | PBW | PBW | PBW |
| 1 | Material of | 74.6 | 74.6 | 74.6 | 74.6 | 111.9 |
| | Step 2C | | | | | |
| 2 | Ti-Pure ® | 11.1 | 11.1 | 11.1 | 11.1 | 16.65 |
| | R960⁽¹⁾ | | | | | |
| 3 | ASP-200 | 16.6 | 16.6 | 16.6 | 16.6 | 24.9 |
| | Clay⁽²⁾ | | | | | |
| 4 | Example 23 | 11.5 | — | — | — | — |
| 5 | CE-5 | — | 10.8 | — | 11.5 | — |
| 6 | CE-6 | — | 0.7 | 0.7 | 0 | 0 |
| 7 | Solvesso | 21 | 21 | 21 | 21 | 31.5 |
| | 100 | | | | | |
| 8 | Ethylene | 15 | 15 | 15 | 15 | 22.5 |
| | glycol butyl | | | | | |
| | ether | | | | | |

⁽¹⁾A titanium dioxide pigment available from DuPont.
⁽²⁾Anhydrous aluminosilicate clay available from Engelhard Corp.

### Step 3C—Preparation of Primers for Example 24 & 25 and CE 4

The procedure used in Step 3A was followed with Examples 24 & 25 and CE-4 using the materials listed in Table 7.

TABLE 7
Preparation of Primers (P6-8) Using Examples 24 & 25 and CE-4

| Component | | P6 | P7 | P8 |
|---|---|---|---|---|
| No. | Material | PBW | PBW | PBW |
| 1 | Material of | 74.6 | 74.6 | 111.9 |
| | Step 2C | | | |
| 2 | Ti-Pure ® | 11.1 | 11.1 | 16.5 |
| | R960⁽¹⁾ | | | |
| 3 | ASP-200 | 16.6 | 16.6 | 24.9 |
| | Clay⁽²⁾ | | | |
| 4 | K-White ® | 5.8 | 5.8 | 8.7 |
| | TC720⁽³⁾ | | | |
| 5 | Example 24 | 11.5 | — | — |
| 6 | Example 25 | — | 11.5 | |
| 7 | CE-4 | — | — | 17.25 |
| 8 | Solvesso | 21 | 21 | 31.5 |
| | 100 | | | |
| 9 | Ethylene | 15 | 15 | 22.5 |
| | glycol butyl | | | |
| | ether | | | |

⁽³⁾An anticorrosive pigment available from Tayca Corp.

### Step 4A—Preparation of Panel Substrates for Examples 1-8, 12-19 and CE-1-4

Coils of G90 hot dipped galvanized steel (HDG), 0.019-0.024 inches (0.48 to 0.61 mm), pretreated with BONDERITE® 1421™ MAKEUP conversion coating and rinsed with PARCOLENE® 62 coating at a level of 150-250 mg/ft² (150-250 mg/0.093 m²) were obtained from Roll Coater, Inc., Indianapolis, Ind. 46240. Also obtained from Roll Coater, Inc., were coils of cold rolled steel (CRS), 0.019-0.024 inches (0.48 to 0.61 mm), pretreated with BONDERITE® 902™ coating at a level of 20-40 mg iron phosphate per square foot (20-40 mg/0.093 m²) and rinsed with PARCOLENE® 62. Both of the coils were cut down to panels of 6″×12′ (15.24 cm×30.48 cm) size for coating. Any rough steel panel edges were removed by either trimming the edges with a panel cutter or by using a de-burring tool with the goal to remove the smallest amount needed to achieve a smooth edge.

### Step 4B—Preparation of Panel Substrates for Example 23-25 and CE-4, 5 & 6

Panels of 090 HDG steel were pretreated with NUPAL® 510R (commercially available from PPG Industries) using the following procedure. A solution of NUPAL® 510R was prepared by adding nine parts of distilled water to one part NUPAL® 510R as received. The resulting mixture was stirred for 2 minutes and the pH was verified to be 2.6 to 3.2, Panels were first dipped in PARCOLENE® 338 (which had been warmed to 60° C.) for 30 seconds. The panels were then rinsed by dipping in distilled water. The wet panels were then dipped in the solution of NUPAL® 510R for 30 seconds, Excess solution was removed by processing the coated panels through a manual rubber Nip roller of the type sold by Schaefer Machine Co, Deep River, Conn. The resulting panels were dried for 5 minutes at 80° C. in an electric oven.

### Step 5A—Preparation of Primer Coated Panels of Examples 1-8, 12-19 and CE-1-4

HDG panels of Step 4A were coated with the primers containing the pigments of Step 3A and a topcoat according to ASTM D4147-99 (Reapproved 2.007). The topcoat used was 3MW73107I Truform ZT Shasta White available from PPG Industries, Inc. The primers were applied and the coated panels were placed in a box oven in which the temperature and cure time were previously determined for the substrate to achieve a peak metal temperature (PMT) of 241° C. First the backside of the panel was coated and placed in the oven for half of the determined cure time at the temperature determined for the substrate to achieve a PMT of 241° C. and with an amount of primer to result in a dry film thickness of 4 to 6 microns. The panels were then coated on the topside with an amount of primer to result in a dry film thickness of 4 to 6 microns and placed in an oven set at the temperature for the time interval necessary to achieve a PMT of 241° C. Next the backside of the panel was coated with topcoat to result in a dry film thickness of 9 to 11 microns and placed in an oven for half of the determined cure time at the temperature determined for the substrate to achieve a PMT of 241° C. Finally, the topside of the primer coated panel was coated with an amount of topcoat to result in a dry film thickness of 18 to 21 microns and placed in an oven set at the temperature for the time interval necessary to achieve a PMT of 241° C.

CRS panels were coated with the primers containing Example 8, Comparative Examples 1, 1-2, 2-A, 3 and 4 as well as primer Control-1 and a topcoat according to ASTM D4147-99 (Reapproved 2007). The topcoat used was 3MW73107I Truform ZT Shasta White available from PPG industries, Inc. The same procedure as that for the HDG panels was used except that after curing the topcoat on the topside of the panel the panel was immersed in cold water to quickly cool the panel.

### Step 5B—Preparation of Panel Substrates for Examples 23-25 and CE-4-8

HDG panels of Step 48 were coated with the coating primers of Step 3B and 3C and a topcoat according to ASTM D4147-99 (Reapproved 2007). The topcoat used was DURASTAR® HP 9000 available from PPG Industries, Inc. The primers were applied using a wire wound drawdown bar and the coated panels were dried for 30 seconds at a peak metal temperature (PMT) of 450° F.(232° C.) resulting in a dry film thickness of about 0.2 mils (5 microns). The backside of the panel was coated with 1BMA73068, a grey polyester backer available from PPG Industries, using a draw down bar #15. The backside coated panels were dried at 270° C. for 2 minutes. The resulting dry film thickness was 0.35-0.40 mils.

A topcoat was applied over the panels using the same procedure except that the amount applied resulted in a dry film thickness of about 0.75 mils (18.75 microns). An additional panel was coated with Comparative Example 7, 1 PMY-5650, a strontium chromate primer available from PPG Industries, using the procedure described above and included in the testing with Example 23 and CE-3 & 4. Another panel was coated with Comparative Example 8, 1PLW5852, a non-chrome primer available from PPG Industries and used in the testing with Examples 24 & 25 and CE-4.

Step 6A—Corrosion Testing and Results for Panels Coated with Examples 1-81219 and CE-1-4

The measurement of corrosion resistance on the coated panels was determined utilizing the test described in ASTM B117-07-Salt Spray Test. In this test, the topside of each coated panel was scribed with a knife or scribing tool to expose the bare metal substrate. The scribed panel was placed into a test chamber where an aqueous salt solution was continuously misted onto the substrate. The chamber was maintained at a constant temperature and exposed to the salt spray environment for 1000 hours for the HDG panels and 500 hours for the CRS panels. After exposure, the scribed panels were removed from the test chamber and evaluated for corrosion along the cut edge and scribe. The cut edge values were reported as an average of a total of 6 measurements, i.e., three measurements of the maximum creep on each of the left and right cut edges in millimeters. The scribe creep values were reported as an average of three measurements of the maximum creep (from scribe to creep) on the vertical scribe in millimeters. Results are illustrated in Tables 8 and 9, with lower values indicating better corrosion resistance results. Results for Comparative Examples 3 and 4 were averaged for the primers used on HDG panels listed in Table 8.

Tabte 8
1000 Hours Corrosion Test Results on HDG Panels

| | Average Scribe | Average Cut Edge |
|---|---|---|
| Example # | Creep (mm) | Creep (mm) |
| 1 | <1 | 3 |
| 2 | 1 | 3 |
| 3 | 4 | 4 |
| 4 | 2 | 2 |
| 5 | <1 | 3 |
| 6 | 1 | 3 |
| 7 | <1 | 3 |
| 8 | <1 | 3 |
| 12 | 2 | 4 |
| 13 | 2 | 3 |
| 14 | 3 | 2 |
| 15 | 2 | 3 |
| 16 | 2 | 2 |
| 17 | 2 | 3 |
| 18 | 2 | 3 |
| 19 | 2 | 3 |
| CE-1 | <0.5 | 3 |
| CE-1A | 1 | 3 |
| CE-1-2 | <1 | 2 |
| CE-2A | 4 | 3 |
| CE-3 | 3 | 3 |
| CE-4 | 6 | 3 |

TABLE 9
500 Hours Corrosion Test Results on CRG Panels

| | Average Scribe | Average Cut Edge |
|---|---|---|
| Example # | Creep (mm) | Creep (mm) |
| Control-1 | 14 | 16 |
| 8 | 3 | 3 |
| CE-1 | 3 | 6 |
| CE-1-2 | 3 | 6 |
| CE-2A | 8 | 15 |
| CE-3 | 8 | 16 |
| CE-4 | 5 | 9 |

Step 6B—Corrosion Testing and Results for Panels Coated with Examples 24 & 25 and CE-4 & 8

The procedure used in Step 6A was followed for the coated HDG panels except that the cut edge creep was reported as an average of the maximum creep on the left and right cut edges in millimeters except as noted for CE-8 in Table 10.

TABLE 10
1000 Hours Corrosion Test Results on HDG Panels

| | Average Scribe | Average Left Cut | Average Right Cut |
|---|---|---|---|
| Example # | Creep (mm) | Edge Creep (mm) | Edge Creep (mm) |
| 24 | 4.8 | 4 | 4 |
| 25 | 0 | 3 | 4 |
| CE-4 | 10.4 | 2.5 | 5 |
| CE-8 | 4-10⁽*⁾ | 3-5⁽*⁾ | 3-5⁽*⁾ |

⁽*⁾CE-8 results are reported as ranges based on replicate results.

Step 6C—Electrochemical Impedance Spectroscopy Measurements on Panels Coated with Example 23, CE-5, 6 & 7 and Control-2

Electrochemical Impedance Spectroscopy (EIS) testing was performed on each of the panels prepared in Step 5B. The EIS measurements were performed using a Princeton Applied Research Potentiostat 273A and Schlumberger HF Frequency Response Analyzer SI 1255 carried out at room temperature in a Faraday cage. The measurements were performed under potentiostatic control using a three electrode arrangement: working electrode, a reference electrode (Ag/AgCl+0.205V) and a Pt mesh counter electrode. The frequency range used for the measurements was from 100 kHz to 10 mHz while the signal amplitude was 20 mV The immersed area was about 16.6 cm². The impedance measurements were taken after exposure of the panels to 0.1M aqueous NaCl solution for 1250 hours of immersion. Higher impedance values are associated with coatings having better barrier properties leading to good performance in corrosion testing. The Bode diagram depicting the impedance test results is included in FIG. 1 showing Example 23 demonstrating a higher impedance than the combination of CE-5 and CE-6; CBS and CE-6 tested separately and Control-2 containing no anticorrosive pigments. Comparative Example 7 containing the strontium chromate primer demonstrated the highest impedance value.

### Part C—Preparation of Electrodepositable Paints and Testing of Examples 9-11, 20-22, 26 and CE-6

### Step 1—Resin Preparation

### Resin 1

Materials 1 through 5 were added to a suitably equipped flask and heated to 125° C. The reaction mixture was allowed to exotherm to 175° C. and cooled to 160-165° C. After the reaction mixture was maintained at 160-165° C. for one hour, materials 6 and 7 were added. The resulting mixture was cooled to 80° C. and materials 8-11 were added. The temperature was maintained at 78° C. until the measured acid value was less than 2. The resulting resin (1288.2 g) was poured into 1100 g of deionized water (material 12) with stirring. The resulting mixture was stirred for 30 minutes then material 13 was added with mixing. The resulting aqueous dispersion had a non-volatile solids content of 30.6 3937% based on following the procedure of ASTM D2369-92.

| # | Material | Weight (gm) |
|---|---|---|
| 1 | EPON ® resin 828⁽⁴⁾ | 533.2 |
| 2 | nonyl phenol | 19.1 |
| 3 | bisphenol A | 198.3 |
| 4 | ethyltriphenyl phosphonium iodide | 0.7 |
| 5 | butoxy propanol | 99.3 |
| 6 | butoxy propanel | 93.9 |
| 7 | methoxy propanol | 50.3 |
| 8 | thiodiethanol | 121.3 |
| 9 | butoxy propanol | 6.9 |
| 10 | deionized water | 32.1 |
| 11 | dimethylol propionic acid | 133.1 |
| 12 | deionized water | 1100 |
| 13 | deionized water | 790 |

⁽⁴⁾Reported to be a diglycidyl ether of bisphenol A and is available from Resolution Chemical Co.

### Resin 2

Materials 1 through 6 were charged to a suitably equipped flask and heated to 125° C. The reaction mixture was allowed exotherm to 175° C. and cool to 160-165° C. After the reaction mixture was maintained at 160-165° C. for one hour, it was cooled to 80° C. and materials 7-10 were added. The temperature was maintained at 78° C. until the measured acid value was less than 2. The resulting resin was poured into deionized water (material 11) with stirring. The mixture was stirred for 30 minutes and materials 12 and 13 were added with mixing. The resulting aqueous dispersion had a non-volatile solids content of 35.6% based on following the procedure of ASTM D2369-92,

| # | Material | Weight (gm) |
|---|---|---|
| 1 | EPON ® resin 880⁽⁵⁾ | 150.8 |
| 2 | butyl carbitol formal | 5.5 |
| 3 | bisphenol A | 56.4 |
| 4 | nonyl phenol | 5.4 |
| 5 | ethyltriphenyl phosphonsum iodide | 0.2 |
| 6 | butyl carbitol formal | 49.5 |
| 7 | thiodiethanol | 34.6 |
| 8 | deionized water | 28.6 |
| 9 | dimethylol propionic acid | 37.9 |
| 10 | n-butoxypropanol | 14.3 |
| 11 | deionized water | 480.8 |
| 12 | ICOMEEN ® T2 surfactant⁽⁶⁾ | 5.8 |
| 13 | deionized water | 25.5 |

⁽⁵⁾Reported to be a polyepoxy resin and is commercially available from Resolution Chemical Co.
⁽⁶⁾A surfactant available from BASF Industries.

### Resin 3

### Preparation of Crosslinker

Materials 1, 2 and 3 were charged to a 4 neck round bottom flask, fitted with a stirrer, temperature measuring probe and N₂ blanket. Material 4 was added slowly allowing the temperature of the resulting reaction mixture to increase to 60° C. The mixture was held at 60° C. for 30 minutes. Material 5 was added over about 2 hours allowing the temperature to increase to a maximum of 110° C. Material 6 was added and the mixture was held at 110° C. until the Infrared analysis of the reaction mixture indicated no measurable isocyanate.

| # | Material | Weight (gm) |
|---|---|---|
| 1 | RUBINATE ® M isocyanate ⁽⁷⁾ | 1876.00 |
| 2 | dibutyltin dilaurate | 0.35 |
| 3 | methyl isobutyl ketone | 21.73 |
| 4 | diethyleneglycol monobutyl ether | 454.24 |
| 5 | ethyleneglycol monobutyl ether | 1323.62 |
| 6 | methylisobutyl ketone | 296.01 |

⁽⁷⁾ Isocyanate available from Huntsman Corporation

### Completion of Resin 3 Preparation

Materials 1, 2, 3, 4 and 5 were charged to a 4 neck round bottom flask, equipped with a stirrer, temperature measuring probe, N₂ blanket and heated to 130° C. The reaction mixture was allowed to exotherm to 150° C. and cooled to 145° C. After two hours at 145° C., materials 6 and 7 were added, Materials 8, 9 and 10 were added and the mixture was held at 122° C. for two hours. The resulting reaction mixture (1991 gm) was poured into a solution of materials 11 and 12 with stirring. Material 13 was then added and the resulting dispersion was mixed for thirty minutes and then material 14 was added with stirring over about 30 minutes and mixed. Material 15 was added and mixed. About 1100 g of water and solvent were distilled off under vacuum at 60-65° C. The resulting aqueous dispersion had a non-volatile solids content of 39.37% based on following the procedure of ASTM D2369-92.

| # | Material | Weight (grams) |
|---|---|---|
| 1 | EPON ® resin 828⁽¹⁾ | 614.68 |
| 2 | Bisphenol A | 265.42 |
| 3 | MACOL ® 98 A MOD 1⁽⁸⁾ | 125.0 |
| 4 | methylisobutyl ketone (mibk) | 31.09 |
| 5 | ethyltriphenyl phosphonium iodide | 0.60 |
| 6 | MACOL ® 98 A MOD 1⁽⁸⁾ | 125.00 |
| 7 | methylisobutyl ketone | 50.10 |
| 8 | Crosslinker from Step 1 | 894.95 |
| 9 | diketimine⁽⁹⁾ | 57.01 |
| 10 | N-methyl ethanolamine | 48.68 |
| 11 | sulfamie acid | 40.52 |
| 12 | H₂O | 1196.9 |
| 13 | gum rosin solution⁽¹⁰⁾ | 17.92 |
| 14 | H₂O | 1623.3 |
| 15 | H₂O | 1100.0 |

⁽⁸⁾Reported to be a low ion version of an ethoxylated Bisphenol A diol available from BASF Corporation.
⁽⁹⁾Reaction product of diethylene triamine and methyl isobutyl ketone at about 72.5% solids in methyl isobutyl ketone.
⁽¹⁰⁾Gum rosin 30% by weight in diethylene glycol mono butyl ether formal.

### Resin 4

### Preparation of Cationic Resin Intermediate

Materials 1-5 were charged into a suitably equipped reaction vessel and heated under a nitrogen atmosphere to 125° C. Material 6 was added. After one hour from the point that the reaction temperature reached 160° C. in an exotherm to 180° C. and then cooled back to 150° C. the reaction was cooled to 130° C. and material 7 was added. The reaction was held at 130° C. until an extrapolated epoxy equivalent weight of 1070 was reached. At the expected epoxy equivalent weight, materials 8 and 9 were added in succession and the mixture allowed to exotherm to around 150° C. One hour after the reaction mixture reached the peak exotherm temperature the reaction was allowed to cool to 125° C. and the resulting mixture was poured into a solution of materials 10 and 11 with stirring. Materials 12, 13 and 14 were added successively, each with mixing. The resulting cationic soap was vacuum striped until the methyl isobutyl ketone content was less than 0.05%.

| # | Material | Weight (gm) |
|---|---|---|
| 1 | EPON ® resin 828⁽¹⁾ | 8940.2 |
| 2 | bisphenol A-ethytene oxide adduct⁽¹¹⁾ | 3242.1 |
| 3 | Bisphenol A | 2795.8 |
| 4 | methyl isobutyl ketone | 781.8 |
| 5 | TETRONIC ® 150R1 surfactant⁽¹²⁾ | 8.1 |
| 6 | benzyldimethylamine | 12.4 |
| 7 | benzyldimethylamine | 18.24 |
| 8 | diketimine⁽⁹⁾ | 1623.6 |
| 9 | n-methylethanolamine | 758.7 |
| 10 | sulfamic acid | 1524.4 |
| 11 | deionized water | 12561 |
| 12 | deionized water | 7170.3 |
| 13 | deionized water | 11267.7 |
| 14 | deionized water | 8450.7 |

⁽¹¹⁾A 6 mole ethoxylate of Bisphenol A.
⁽¹²⁾A nonionic surfactant available from BASF.

### Completion of Resin 4 Preparation

Material 1 was charged into a suitably equipped reactor with the temperature set to 70° C. to heat the reactor. Materials 2 and 3 were added sequentially. After the reaction mixture reached 70° C. material 4 was added over a 15 minute interval. Material 5 was added and the temperature of the reactor was maintained at 70° C. for 45 minutes. The reactor was then heated to 88° C. and maintained at this temperature for 3 hours. After 2½ hours of this 3 hour interval, materials 6 and 7 were added to the reactor. After heating for a total of 3 hours, the heat was turned off and material 8 was added to the mixture. The reactor temperature was allowed to cool to 32° C. and material 9 was added and the reactor temperature was maintained at 32° C. for 1 hour. The resulting aqueous dispersion had a nonvolatile solids content of 18.0% based on following the procedure of ASTM D2369-92.

| # | Material | Parts by weight |
|---|---|---|
| 1 | Cationic resin intermediate from Step 1 | 50.10 |
| 2 | propylene glycol mono propyl ether | 1.34 |
| 3 | deionized Water | 1.47 |
| 4 | EPON ® resin 828⁽¹⁾ in solution⁽¹³⁾ | 781.8 |
| 5 | Ethylene Glycol mono butyl ether | 1.34 |
| 6 | RHODAMEEN ® C-5 surfactant⁽¹⁴⁾ | 1.98 |
| 7 | Deionized water | 0.93 |
| 8 | Deionized water | 4.00 |
| 9 | Deionized water | 14.97 |

⁽¹³⁾A solution of 85 weight percent EPON ® resin 828 and 15 weight percent propylene glycol methyl ether. The weight percent reported was based on the total weight of the solution.
⁽¹⁴⁾Reported to be an ethoxylated cocoamine surfactant available from Rhodia Inc.

### Resin 5

Materials 1, 2, and 3 were sequentially added to a suitably equipped reactor and the resulting mixture was heated to 125° C. Material 4 was added and the reaction was allowed to exotherm and the temperature was adjusted to 160° C. After the reaction mixture was maintained at 160° C. for 1 hr, material 5 was added, Material 6 was added with stirring over a 10 minute interval, Material 7 was used to rinse the lines into the reactor and the reaction was allowed to exotherm. The temperature was adjusted to 125-130° C. and maintained at that temperature for 3 hours, Material 8 was added to the reactor and material 9 was used to rinse the lines into the reactor. After mixing for 10 minutes, materials 10 and 11 were added. After mixing for 30 minutes, material 12 was added. The resulting aqueous dispersion had a non-volatile solids content of 45.0% based on following the procedure of ASTM 02369-92.

| # | Material | Parts by weight |
|---|---|---|
| 1 | EPON ® resin 828⁽¹⁾ | 241.1 |
| 2 | Bisphenol A | 73.5 |
| 3 | butyl carbitol formal | 35.1 |
| 4 | ethyl triphenyl phosphonium iodide | 0.2 |
| 5 | butyl carbitol formal | 60.1 |
| 6 | JEFFAMINE ® D-2000 polyetheramine⁽¹⁵⁾ | 855.4 |
| 7 | butyl carbitol formal | 26.1 |
| 8 | RHODAMEEN ® C-5 surfactant⁽¹⁴⁾ | 65.1 |
| 9 | butyl carbitol formal | 10.1 |
| 10 | lactic Acid | 43.5 |
| 11 | deionized water | 1322.7 |
| 12 | deionized water | 303.7 |

⁽¹⁵⁾Reported to be a difunctional, primary amine with an average molecular weight of about 2000 available from Huntsman Corp.

### Resin 6

A mixture of 673 parts by weight (pbw) ethylene glycol butyl ether, 7.80 pbw of di-tert-butyl peroxide, and 7.80 pbw of cumene hydroperoxide were added with mixing to a suitable vessel equipped with two addition funnels, temperature control, and a condenser. The following were preblended: 171.83 pbw of styrene, 124.93 pbw of methacrylic acid, 23.51 pbw of tert-dodecyl mercaptan, and 482.9 pbw of n-butyl acrylate and added to the reaction vessel. The vessel was heated to a set point of 293° F. (145° C.) during which an exotherm occurred at 260° F. (126.7° C.) resulting in a temperature increase from 293-320° F. (145-160° C.). The following materials in the monomer mix were preblended into an addition funnel: 1572.0 pbw of Styrene, 1143.1 pbw of methacrylic acid, 213.5 pbw of tert-dodecyl mercaptan, and 4418.1 pbw of n-butyl acrylate. In a separate addition funnel, the following materials in the peroxide mix were preblended: 156 pbw ethylene glycol butyl ether, 70.5 pbw di-tert butyl peroxide, and 70.5 pbw cumene hydroperoxide. After the initial exotherm was complete and the reaction cooled to 293° F. (145° C.), the monomer mix and the peroxide mix were slowly added separately and simultaneously to the reaction vessel with the addition of both mixtures completing at 180 minutes. Cooling was used as needed to maintain a temperature between 293° F. (145° C.) and 310° F. (154.4° C.). The reaction mixture was then cooled to 290° F. (143.3° C.), and a blend of 18.5 pbw di-tert-butyl peroxide and 29.9 pbw ethylene glycol butyl ether was then charged to the reaction vessel. The reaction was then stirred for 2 hours while cooling to 275-285° F. (135° C.). Another blend of 18.5 pbw di-tert-butyl peroxide and 51.4 pbw ethylene glycol butyl ether was added and the reaction was stirred for an additional 2 hrs while maintaining 275-285° F. (135-140.6° C.). The reaction was cooled to 240° F. (115.6° C.) and 931.5 pbw n-butyl alcohol, 21.5 pbw of ethylene glycol butyl ether were charged to the reaction mixture. The resulting mixture was left to cool to below 180° F. (82.2° C.). The determined non-volatile content of the resin was 80% as measured by weight loss of a sample heated to 110° C. for 1 hour.

### Resin 7

A mixture of 819.2 parts by weight (pbw) of EPON® resin 828, 263.5 pbw of bisphenol A, and 209.4 pbw of 2-n-butoxy-1-ethanol was heated to 115° C. At that temperature, 0.8 pbw of ethyl triphenyl phosphonium iodide was added. The resulting mixture was heated and held at a temperature of at least 165° C. for one hour. As the mixture was allowed to cool to 88° C., 51.3 pbw of Ektasolve EEH solvent and 23.2 pbw of 2-n-butoxy-4-ethanol were added. At 88° C., a slurry consisting of 32.1 pbw of 85% o-phosphoric acid, 18.9 pbw phenylphosphonic acid, and 6.9 pbw of Ektasolve EEH was added. The reaction mixture was subsequently maintained at a temperature of at least 120° C. for 30 minutes. Afterwards, the mixture was cooled to 100° C. and 71.5 pbw of deionized water was added gradually. After the water was added, a temperature of about 100° C. was maintained for 2 hours. Then the reaction mixture was cooled to 90° C. and 90.0 pbw of diisopropanolamine was added, followed by 413.0 pbw of CYMEL® 1130 resin and 3.0 pbw of deionized water. After 30 minutes of mixing, 1800.0 pbw of this mixture was dispersed into 1506.0 pbw of deionized water with mixing. An additional 348.0 pbw of deionized water was added to yield a homogeneous dispersion which had a solids content of 39.5% after 1 hour at 110° C.

### Step 4—Paste Preparation

### Catalyst Paste

Materials 1-4 were sequentially added to a suitable vessel under high shear agitation. When the materials were thoroughly blended, the resulting dispersion was transferred to a vertical sand mill and ground to a Hegman value of about 7.25.

| # | Material | Parts by weight |
|---|---|---|
| 1 | Resin 2 | 527.7 |
| 2 | n-butoxypropanol | 6.9 |
| 3 | dibutyltin oxide | 312.0 |
| 4 | deionized water | 133.61 |

### Control Paste 1

Materials 1-7 were sequentially added to a suitable vessel under high shear agitation. When the materials were thoroughly blended, the resulting dispersion was transferred to an Eiger Mini Mill 250 with zircoa media (1.2-1.7 mm. The dispersion was ground for 30 minutes resulting in a Hegman reading of greater than 8.

| # | Material | PARTS BY WEIGHT |
|---|---|---|
| 1 | Resin 1 | 525.3 |
| 2 | SURFYNOL ® GA surfactant⁽¹⁶⁾ | 1.35 |
| 3 | TiO₂ (CR800)⁽¹⁷⁾ | 40.3 |
| 4 | Carbon Black CSX 333⁽¹⁸⁾ | 4.39 |
| 5 | Kaolin Clay ASP 200⁽²⁾ | 316.6 |
| 6 | Catalyst Paste | 175.3 |
| 7 | deionized water | 70.98 |

⁽¹⁶⁾Reported to be a blend of nonionic surfactants available from Air Products.
⁽¹⁷⁾A pigmentary grade TiO₂ available from Kerr McGee Inc.
⁽¹⁸⁾Carbon black pigment available from Cabot Specialty Chemicals.

### Pastes 1-4

Pastes 1-4 were prepared by sequentially adding materials 1-11 as indicated in Table 11 below based on parts by weight to a suitably equipped vessel under high shear agitation. CE-6A, Lo-Vel® 2003 silica that was ummilled, was used in Paste 4. When the ingredients were thoroughly blended, the resulting pigment dispersions were transferred to an Eiger Mini Mill 250 with zircoa media (1.2-1.7 mm diameter). Each pigment dispersion was ground until a Hegman reading of 8 or higher was observed which typically took 20-35 minutes.

TABLE 11
Description of Pastes 1-4

| # | Material | Paste 1 | Paste 2 | Paste 3 | Paste 4 |
|---|---|---|---|---|---|
| 1 | Resin 1 | 525.3 | 525.3 | 525.3 | 525.3 |
| 2 | SURFYNOL ® GA | 1.35 | 1.35 | 1.35 | 1.35 |
| | surfactant⁽¹⁶⁾ | | | | |
| 3 | TiO₂ (CR800)⁽¹⁷⁾ | 40.3 | 40.3 | 40.3 | 40.3 |
| 4 | Carbon Black CSX 333⁽¹⁸⁾ | 4.39 | 4.39 | 4.39 | 4.39 |
| 5 | Kaolin Clay ASP 200⁽²⁾ | 173.25 | 148.3 | 148.3 | 148.3 |
| 6 | Example 9 | 143.3 | 0 | 0 | 0 |
| 7 | Example 10 | 0 | 168.26 | 0 | 0 |
| 8 | Example 11 | 0 | 0 | 168.26 | 0 |
| 9 | CE-6A | 0 | 0 | 0 | 168.26 |
| 10 | Catalyst Paste | 175.3 | 175.3 | 175.3 | 175.3 |
| 11 | deionized water | 87.6 | 117.6 | 92.6 | 78 |

### Pastes 5-7 and CP-2

Pastes 5-7 and Control Paste 2 (CP-2) were prepared by sequentially adding materials 1-9 as indicated in Table 12 below based on parts by weight to a suitably equipped vessel under high shear agitation (30 minutes). When the ingredients were thoroughly blended, the resulting pigment dispersions were transferred to a Vertical Media mill using zircoa media (1.8-2.2 mm diameter zircoa beads). Each pigment dispersion was ground until a Hegman reading of 7 or higher was observed which typically took 45 minutes.

TABLE 12
Description of Pastes 5-7 and CP-2

| # | Material | Paste 5 | Paste 6 | Paste 7 | CP-2 |
|---|---|---|---|---|---|
| 1 | Resin 1 | 455.7 | 455.7 | 455.7 | 441.9 |
| 2 | SURFYNOL ® GA | 1.12 | 1.12 | 1.12 | 1.14 |
| | surfactant⁽¹⁶⁾ | | | | |
| 3 | TiO₂ (CR800)⁽¹⁷⁾ | 33.5 | 33.5 | 33.5 | 33.9 |
| 4 | Carbon Black CSX 333⁽¹⁸⁾ | 3.64 | 3.64 | 3.64 | 3.69 |
| 5 | Kaolin Clay ASP 200⁽²⁾ | 0 | 136.1 | 178.27 | 266.3 |
| 6 | Example 20 | 262.62 | 0 | 0 | 0 |
| 7 | Example 21 | 0 | 126.54 | 0 | 0 |
| 8 | Example 22 | 0 | 0 | 84.36 | 0 |
| 9 | deionized water | 43.48 | 43.48 | 43.48 | 53.03 |
| | Weight Percent of Butyl | 1.64 | 3.16 | 3.16 | 0 |
| | Stannoic acid resulting in | | | | |
| | each Paste | | | | |

### Paste 8

Paste 8 was prepared by sequentially adding materials 1-3 as indicated in Table 13 below based on parts by weight to a suitably equipped vessel under high shear agitation. When the ingredients were thoroughly blended, the resulting pigment dispersions were transferred to a Vertical Media mill using zircoa media (1.8-2.2 mm diameter zircoa beads). Each pigment dispersion was ground until a Hegman reading of 7 or higher was observed which typically took 45 minutes.

TABLE 13
Preparation of Paste 8

| # | Material | PARTS BY WEIGHT |
|---|---|---|
| 1 | Resin 6 | 80 |
| 2 | Ethylene glycol monobutyl ether | 102 |
| 3 | Example 26 | 40 |

### Step 3—Preparation of Electrodepositable Paints (EP) 1-5

The materials listed in Table 14 were used to prepare EP 1-5 as described hereinafter. Materials 1 through 5 were added sequentially with agitation to a suitable equipped 4 liter container. Materials 6 and 7 were preblended and added to the container with agitation. Materials 8 and 9 were preblended and added to the container with agitation. The resulting mixture was stirred for 20 minutes. Materials 10A-10E were individually added with material 11 to make paints EP-1 through EP-5, respectively. Each of the resulting paints was stirred a minimum of 24 hrs then ultra-filtered to remove 20% by weight. The ultra-filtrate removed from each paint was replaced with an equal weight of deionized water.

TABLE 14
Description of EP 1-5

| # | Material | EP-1 | EP-2 | EP-3 | EP-4 | EP-5 |
|---|---|---|---|---|---|---|
| 1 | Resin 5 | 161.0 | 161.0 | 161.0 | 161.0 | 161.0 |
| 2 | Butyl carbitol formal | 12.3 | 12.3 | 12.3 | 12.3 | 12.3 |
| 3 | Resin 4 | 124.3 | 124.3 | 124.3 | 124.3 | 124.3 |
| 4 | Resin 3 | 1368.2 | 1368.2 | 1368.2 | 1368.2 | 1368.2 |
| 5 | propylene glycol mono- | 9.7 | 9.7 | 9.7 | 9.7 | 9.7 |
| | methyl ether | | | | | |
| 6 | deionized water | 118.1 | 118.1 | 118.1 | 118.1 | 118.1 |
| 7 | Silver nitrate | 0.024 | 0.024 | 0.024 | 0.024 | 0.024 |
| 8 | deionized water | 118.1 | 118.1 | 118.1 | 118.1 | 118.1 |
| 9 | KATHON ® LX biocide⁽¹⁷⁾ | 0.96 | 0.96 | 0.96 | 0.96 | 0.96 |
| 10A | Control Paste 1 | 230.2 | 0 | 0 | 0 | 0 |
| 10B | Paste 1 | 0 | 245.4 | 0 | 0 | 0 |
| 10C | Paste 2 | 0 | 0 | 252.5 | 0 | 0 |
| 10D | Paste 3 | 0 | 0 | 0 | 253.9 | 0 |
| 10E | Paste 4 | 0 | 0 | 0 | 0 | 283.1 |
| 11 | Deionized water | 1657 | 1642.1 | 1635.1 | 1633.6 | 1604.5 |

(16) A biocide available from Rohm and Haas Inc.

### Preparation of Electrodepositable Paints (EP) 6-9

The materials listed in Table 15 were used to prepare EP 6-9 as described hereinafter. Materials 1 through 3 were added sequentially with agitation to a suitable equipped 4 liter container and stirred for 15 minutes, Materials 4 and 5 were pre blended and added to the container with agitation. Some quantity of material 7 (deionized water) was added as needed. The resulting mixture was stirred for 20 minutes. Materials 6A-6D were individually added with material 7 to make paints EP-6 through EP-9, respectively. Each of the resulting paints was stirred a minimum of 24 hrs then ultra-filtered to remove 20% by weight. The ultra-filtrate removed from each paint was replaced with an equal weight of deionized water.

TABLE 15
Description of EP 6-9

| # | Material | EP-6 | EP-7 | EP-8 | EP-9 |
|---|---|---|---|---|---|
| 1 | Resin 5 | 161.0 | 161.0 | 161.0 | 161.0 |
| 2 | butyl carbitol formal | 12.3 | 12.3 | 12.3 | 12.3 |
| 3 | Resin 4 | 124.4 | 124.4 | 124.4 | 124.4 |
| 4 | Resin 3 | 1359.2 | 1359.2 | 1359.2 | 1359.2 |
| 5 | propylene glycol mono- | 9.6 | 9.6 | 9.6 | 9.6 |
| | methyl ether | | | | |
| 6A | Paste 5 | 233 | 0 | 0 | 0 |
| 6B | Paste 6 | 0 | 233 | 0 | 0 |
| 6C | Paste 7 | 0 | 0 | 233 | 0 |
| 6D | Control Paste 2 | 0 | 0 | 0 | 230 |
| 7 | Deionized water | 1901 | 1901 | 1901 | 1901 |
| | Weight percent of BSA | 0.52 | 1.01 | 1.01 | 0 |
| | on paint Solids | | | | |

### Preparation of Electrodepositable Paints (EP) 10-11

The materials listed in Table 16 were used to prepare EP 10 and 11 as described hereinafter. Materials 1 through 4 were added sequentially with agitation to a suitable equipped 4 liter container and stirred to produce a resinous blend having a solids content of 20% with a pigment to binder ratio of 0.2. Each of the resulting paints was stirred a minimum of 24 hrs than ultra-filtered to remove 50% by weight. The ultra-filtrate removed from each paint was replaced with an equal weight of deionized water.

TABLE 16
Description of EP 10 AND 11

| # | Material | EP-10 | EP-11 |
|---|---|---|---|
| 1 | Resin 7 | 1307.7 | 1312.0 |
| 2 | Pigment Paste⁽¹⁹⁾ | 232.8 | 250.9 |
| 3 | Paste 8 | 54.9 | 0 |
| 4 | Deionized water | 1404.5 | 1437.0 |

⁽¹⁹⁾Grey pigment paste ACPP-1120 available from PPG Industries.

### Step 4A—Coated Panel Preparation for EP 1-5

Electrodepositable Paints 1-5 were each heated to between 90 and 94° F. (32 to 34° C.′ and deposited onto 4 inch by 6 inch (10.16 cm by 15.24 cm) clean steel panels commercially available from ACT Laboratories, Inc. as APR28110 and APR28630 by applying 200-240 volts between the test panel and a stainless steel anode for a set amount of time. The coated panels were cured at 160° C. or 170° C. for 30 minutes in an electric oven as indicated in the table below. The allotted time, temperature, and voltage for the coatout was adjusted to have a final film build after cure of 18 to 22 microns.

### Step 4B—Coated Panel Preparation for EP 6-9

The procedure used to deposit Electrodepositable Paints 1-5 was used with EP 6-9 except that phosphated steel panels (APR 28630) were used and the panels were cured for 20 minutes at the temperatures indicated hereafter.

### Step 4C—Coated Panel Preparation for EP 10 and 11

The procedure used to deposit Electrodepositable Paints 1-5 was used with EP 10 and 11 except for the following: aluminum panels (2024 Clad; 2024 Bare; & 7075 Bare) that were cleaned by abrading (rubbing 5-10 rubs along the axis of the panel and 5-10 rubs across the panel with a Scotch-Brite™ pad) and rinsed with methyl isobutyl ketone were used; the paints were deposited by applying 100-170 volts; and the panels were cured for 20 minutes at 200° F. (93° C.).

Step 5A—Corrosion Testing of Panels Coated with EP-1-5

Each coated panel was scribed with a line approximately 3-4 inches (7.62 to 10.16 cm) long from top to bottom in the center of each panel using a carbide tipped scribe and a straight edge. The scribe penetrated through all coatings, including any pretreatment coating into the substrate. The test panels were then subjected to cyclic corrosion testing by rotating test panels or 26 cycles through a salt solution, room temperature dry, and humidity and low temperature in accordance with General Motors Test Method 54-26 “Scab Corrosion Creepback of Paint Systems on Metal Substrates” as detailed in General Motors Engineering Materials and Process Standards available from General Motors Corporation. Corrosion was measured as the maximum width of paint no longer adhering to the panel around the scribe and is reported in mm. The results are listed in the Table 17 with lower values indicating better corrosion resistance results.

TABLE 17
Corrosion Test Results for EP-1-5

| Electrocoat | Cure Temperature | Corrosion Width |
|---|---|---|
| paint | (° C.) | (mm) |
| EP-1 | 170 | 22 |
| EP-1 | 160 | 22 |
| EP-2 | 170 | 13 |
| EP-2 | 160 | 9 |
| EP-3 | 170 | 21 |
| EP-3 | 160 | 20 |
| EP-4 | 170 | 7 |
| EP-4 | 160 | 8 |
| EP-5 | 170 | 19 |
| EP-5 | 160 | 19 |

Step 5B—Solvent Resistance Testing of Panels Coated with EP-6-9

The coatings on the panels designated EP 6-9 were tested for solvent resistance using ASTM D-5402-06 Method A using acetone with the following exceptions: there was no water cleaning of the panels and 100 double rubs were performed using a heavy duty paper towel in place of a cotton cloth. The following ratings listed in Table 18 were used for each of the coatings at each of the curing temperatures. The higher the rating, the more resistant the coating to solvent. Results are listed in Table 19.

TABLE 18
Double Rub Ratings

```
  0—through to substrate < 20 rubs
  1—Through to substrate in 20-50 rubs
  2—Through to substrate in 50-100 rubs
  3—Very severely marred. Scratches to metal easily
  4—Severely marred only over area rubbed. Can Scratch to metal
  5—Marred over rub area. can scratch through to metal
  6—Marred uniformly in center of rub area, difficult, but possible
to scratch to metal
  7—Non uniform marring over rub area, can not scratch to metal
  8—Scratching, very little marring of rub area, can not scratch to metal
  9—Slight scratching of rub area, can not scratch to metal
10—No visible damage
```

TABLE 19
Solvent Resistance Results for EP
6-9 Cured at Different Temperatures

| | 300° F.(148.9° C.) | 320° F.(160.0° C.) | 340° F.(171.1° C.) |
|---|---|---|---|
| EP 8 | 0 | 0 | 7 |
| EP 7 | 0 | 8 | 8 |
| EP 8 | 0 | 9 | 9 |
| EP 9 | 0 | 0 | 0 |

### Step 5C—Corrosion Testing of EP 10 and 11

The scribed panels were tested for 3000 hours in a salt spray corrosion test according to ASTM B117-07 as described in Part B, Step 6A except that the panels were scribed in an X (11 cm by 11 cm) using a GRAVOGRAPH® IM4 engraving marking system equipped with a flat bottom mill bit 1 mm wide. The width in mm of the corrosion on the scribe for each of the samples is listed below in Table 20.

TABLE 20
Scribe Corrosion Width (mm) for EP-10 & EP-11

| Material | EP-10 | EP-11 |
|---|---|---|
| 2024 Clad Al | 2.5 | 4.7 |
| 2024 Bare Al | 10.9 | 11.0 |
| 7075 Bare Al | 7.2 | 17.0 |

### Part D—Preparation of Example 27 and TEM

Cerium oxide (5.58 grams) obtained from Aldrich Chemicals as 98% pure and Lo-Vel® 2003 silica (84.42 grams) were weighed, transferred to a 2 liter ball mill container and mixed with a spatula to dry-blend the ingredients. Alumina cylinders (220 individual pieces measuring 1.3 cm long by 1.3 cm in diameter) were placed into the ball mill container. The container was sealed and the dry-blended materials were dry-milled for 3 hours at a rotational speed of 1 revolution per second. After the milling, the sample was classified using a 0.25 mm sieve. A transmission electron micrograph (TEM) of a sample of Example 27 is included as FIG. 2. The particle size distribution was as follows:

% Volume
Particle size distribution of Example 27 (microns)

| | | |
|---|---|---|
| ≦2% | ≦50% | ≦99.9% |
| 3.7 | 26.4 | 261.0 |

It is to be understood that the present description and examples illustrates aspects of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments or examples disclosed herein, but is intended to cover modifications that are within the spirit and scope of the invention, as defined by the appended claims.

Whereas particular embodiments of this invention have been described above for purposes of illustration, it will be evident to those skilled in the art that numerous variations of the details of the present invention may be made without departing from the invention as defined in the appended claims.

Therefore, we claim:

1. A method of preparing a multi-phase particulate, the method comprising:
(1) blending together
(a) a dispersed phase component comprising a metal, a metal oxide, an organometallic compound, salts thereof, and/or mixtures thereof, and
(b) a bulk phase component comprising an inorganic material different from the dispersed phase component to form an admixture, wherein the dispersed phase component (a) is present in an amount ranging from 0.5 to 60 percent by weight based on total combined weight of the dispersed phase component (a) and the bulk phase component (b); and
(2) dry-milling and/or compressing the admixture for a time and at a pressure sufficient to disperse the dispersed phase component in and bind the dispersed phase component to the bulk phase component, thereby forming a multi-phase particulate.

2. The method of claim 1, wherein in step (1), the dispersed phase component (a) and the bulk phase component (b) are dry-blended together to form an admixture.

3. A method of preparing a multi-phase particulate the method comprising:
(1) blending together
(a) a dispersed phase component comprising a metal, a metal oxide, an organometallic compound, salts thereof, and/or mixtures thereof, and
(b) an aqueous slurry of a bulk phase component comprising an inorganic material different from the dispersed phase component to form an aqueous slurry admixture, wherein the dispersed phase component (a) is present in an amount ranging from 0.5 to 60 percent by weight based on total combined weight of the dispersed phase component (a) and the bulk phase component (b);
(2) drying the aqueous slurry admixture to form a dry admixture; and
(3) dry-milling and/or compressing the dry admixture for a time and at a pressure sufficient to disperse the dispersed phase component in and bind the dispersed phase component to the bulk phase component, thereby forming a multi-phase particulate.

4. The method of claim 3, wherein the dispersed phase component (a) is in the form of an aqueous slurry.

5. The method of claim 1, further comprising further miffing and classifying the multi-phase particulate formed in (2), and/or further drying the multi-phase particulate formed in (2).

6. A coating composition comprising:
(a) a resinous binder; and
(b) a multi-phase particulate dispersed in the resinous binder,
the mufti-phase particulate comprising a dispersed phase component dispersed in and bound to a bulk phase component,
the dispersed phase component comprising a metal, a metal oxide, an organometallic compound, salts thereof, and/or mixtures thereof,
the bulk phase component comprising an inorganic material different from the dispersed phase component,
wherein the dispersed phase component is present in an amount ranging from 0.5 to 60 percent by weight based on total combined weight of the dispersed phase component and the bulk phase component.

7. A method of improving the corrosion resistance of a metaffic substrate comprising:
providing a metallic substrate; and
applying the coating composition of claim 6 over the metallic substrate surface to form coating layer on at least a portion of the metallic substrate surface.

8. A multilayer composite comprising:
(a) a metallic substrate, and
(b) at least one coating layer over at least a portion of the metallic substrate, the coating layer formed from a coating composition comprising
(i) a resinous binder; and
(ii) a multi-phase particulate dispersed in the resinous binder,
the multi-phase particulate comprising a dispersed phase component dispersed in and bound to a bulk phase component,
the dispersed phase component comprising a metal, a metal oxide, an organometallic compound, salts thereof, and/or mixtures thereof,
the bulk phase component comprising an inorganic material different from the dispersed phase component,
wherein the dispersed phase component is present in an amount ranging from 0.5 to 60 percent by weight based on total combined weight of the dispersed phase component and the bulk phase component.

9. The multi-layer composite of claim 8, wherein the metallic substrate comprises cold rolled steel; stainless steel; steel surface-treated with any of zinc metal, zinc compounds and zinc alloys; copper; magnesium, and alloys thereof; aluminum alloys; zinc-aluminum alloys; aluminum plated steel; aluminum alloy plated steel substrates, and aluminum, aluminum alloys, aluminum clad aluminum alloys.

10. The multi-layer composite of claim 8, wherein the metallic substrate comprises cold rolled steel pretreated with (1) a solution of a metal phosphate solution, (2) an aqueous solution containing a Group IIA, Group IIIA, Group IB, Group IIB, Group IIIB, Group IVB, Group VIB, Group VIIB, and/or Group VIII metal, (3) an organophosphate solution, and/or (4) an organophosphonate solution.

11. The multi-layer composite of claim 8, wherein at a frequency of 1 Hertz or lower, the multi-layer composite maintains an impedance of at least 1×10⁸ ohm*cm² for at least 1000 hours of exposure testing in accordance with ASTM B117.
